(19) United States
(12) Patent Application Publication
(10) Pub. No.: US 2026/0188301 A1
(43) Pub. Date: Jul. 2, 2026

(54) DISTRIBUTED PROCESSING ARCHITECTURE FOR ATTENTION MODELING

(71) Applicant: Attention Labs Incorporated, Newark, DE (US)

(72) Inventors: David J. Kim, Toronto (CA); Omar Abbasi, Guelph (CA); Daniyal Anjum, Milton (CA); Bonny Banerjee, Collierville, TN (US)

(21) Appl. No.: 19/241,399

(22) Filed: Jun. 18, 2025

Related U.S. Application Data
(63) Continuation of application No. 19/236,996, filed on Jun. 13, 2025.
Application No. 19/236,996 is a continuation of application No. 19/221,496, filed on May 28, 2025.
Application No. 19/221,496 is a continuation of application No. PCT/US25/29916, filed on May 18, 2025.
Application No. PCT/US25/29916 is a continuation-in-part of application No. 19/093,220, filed on Mar. 27, 2025.
Application No. 19/093,220 is a continuation of application No. 19/069,128, filed on Mar. 3, 2025.
(60) Provisional application No. 63/739,560, filed on Dec. 28, 2024.
(60) Provisional application No. 63/741,998, filed on Jan. 6, 2025.

(51) Int. Cl. G10L 15/02; G10L 15/16

(52) U.S. Cl. CPC G10L 15/02; G10L 15/16

(57) ABSTRACT

Method for dynamic conversation graph generation, including receiving as input multimodal sensor data, and building a real-time representation of dynamic social interactions having varying numbers of participants and sub-group formations over time, in the form of a graph with dynamic edge weights.

### REFERENCE TO RELATED APPLICATION

This application claims the benefit of (i) U.S. Provisional Application No. 63/739,560 entitled ATTENTION MODELING IN MULTI-SPEAKER ENVIRONMENTS and filed on Dec. 28, 2024 by inventors David J. Kim, Omar Abbasi and Daniyal Anjum, of (ii) U.S. Provisional Application No. 63/741,998 entitled ATTENTION MODELING IN MULTI-SPEAKER ENVIRONMENTS and filed on Jan. 6, 2025 by inventors David J. Kim, Omar Abbasi and Daniyal Anjum, of (iii) U.S. patent application Ser. No. 19/069,028 entitled ATTENTION MODELING IN MULTI-SPEAKER ENVIRONMENTS filed on Mar. 3, 2025 by inventors David J. Kim, Omar Abbasi and Daniyal Anjum, of (iv) U.S. patent application Ser. No. 19/093,220 entitled SELECTIVE AUDITORY ATTENTION IN MULTI-PARTICIPANT ENVIRONMENTS filed on Mar. 27, 2025 by inventors David J. Kim, Omar Abbasi and Daniyal Anjum, of (v) U.S. patent application Ser. No. 19/221,496 entitled SELECTIVE AUDITORY ATTENTION IN MULTI-PARTICIPANT ENVIRONMENTS filed on May 28, 2025 by inventors David J. Kim, Omar Abbasi, Daniyal Anjum and Bonny Banerjee, of (vi) U.S. patent application Ser. No. 19/236,996 entitled DYNAMIC GENERATION GRAPH GENERSATION filed on Jun. 13, 2025 by inventors avid J. Kim, Omar Abbasi, Daniyal Anjum and Bonny Banerjee, and of (vii) PCT Application No. PCT/US25/29916 entitled SELECTIVE AUDITORY ATTENTION IN MULTI-PARTICIPANT ENVIRONMENTS filed on May 18, 2025 by inventors David J. Kim, Omar Abbasi, Daniyal Anjum and Bonny Banerjee, the contents all of which are incorporated herein by reference in their entireties.

### FIELD OF THE INVENTION

The present invention relates to auditory attention modeling and management in multi-participant environments.

### BACKGROUND OF THE INVENTION

In complex auditory environments, the human auditory system naturally focuses attention on specific speakers of interest while filtering out background noise, commonly known as the “cocktail party effect.” This biological capability enables selective attention to individual conversations in noisy environments. Modern wearable devices and mixed reality systems aim to replicate and enhance this natural ability, presenting both significant opportunities and technical challenges in multi-speaker scenarios.

Reference is made to FIG. 1, which is a prior art diagram of a “cocktail party effect”. Multiple conversations are taking place simultaneously at the party. Imagine if each participant is wearing a hearing device. From the perspective of a non-human, the audio output from a hearing device would correspond to a sum of simultaneous conversations. Any kind of audio processing would be very difficult if not impossible. In fact, even for the human ear, the ability to focus on any one of the simultaneous conversations is challenging.

Current technology enables basic speaker identification and audio processing in controlled environments. However, real-world social interactions involve dynamic groups, varying environmental conditions, and complex conversation patterns that exceed capabilities of existing systems. A technical challenge lies in developing comprehensive solutions that can handle the full complexity of natural multi-participant conversations while operating within constraints of wearable devices.

Key technical challenges in developing such systems include:
1. processing and analyzing multiple simultaneous audio streams in real-time while maintaining low latency;
2. operating efficiently on devices with limited computational resources;
3. adapting to changing group dynamics and conversation patterns;
4. integrating multiple data types including audio, spatial and participant interaction data;
5. maintaining privacy and security of conversation data;
6. managing attention across multiple concurrent conversation groups;
7. providing seamless audio transitions as attention shifts between speakers; and
8. scaling system performance with increasing numbers of participants.

Existing approaches to audio processing and speaker separation primarily focus on isolated aspects of the problem. Traditional audio processing methods lack the flexibility required for dynamic social scenarios. While machine learning approaches show promise, they often demand substantial computational resources that exceed capabilities of wearable devices. Rule-based systems struggle to handle complexity and uncertainty inherent in natural conversations.

### SUMMARY

Embodiments of the present invention, designated SAA (Selective Auditory Attention) enable multiple participants wearing smart devices with audio output to conduct multiple simultaneous conversations. The smart devices may be, for example, one or more headsets, glasses and helmets. Multiple audio streams are transmitted to the devices, and the devices selectively set audio gains on the streams so as to dynamically block those streams to which each participant is not paying attention.

The devices receive and process multimodal inputs, including spatial, rotational, audio, visual, eye-tracking and EEG, from sensors. The sensors may be, for example, one or more of cameras, speakers, eye-trackers and electrodes.

For N participants, attention relationships are computed using two complementary methods:
(a) A probability matrix P{i,j} where i and j range from 1 to N, where p_ij represents the probability that participant i is paying attention to participant j. Each participant generates an audio stream, and their device receives N−1 audio streams from other participants. The gain on incoming stream j in participant i's device is set relative to p_ij.
(b) A unique pair analysis where N*(N−1)/2 unique participant pairs are generated, with each pair assigned a probability value representing likelihood of conversation between those participants. Audio stream adjustments are made based on these pair probabilities.

The core engine of SAA is a set of machine learning models that interact with each other in arbitrary ways, which processes multimodal sensor data as input, and generates a probability matrix P{i,j} and a conversational graph as output. Nodes of the conversational graph represent participants, and edges connect participants who are paying attention to one another. The machine learning models operate on a local processing system within the physical environment where the conversations take place. The machine learning models are trained by various group conversation scenarios. The inputs are preprocessed to extract features such as those pertaining to gazes and poses, which are fed to the machine learning models for analysis. The processing system receives sensor data from the participant devices and performs real-time analysis to determine attention patterns. Group conversations are dynamic processes, with participants joining and leaving ad-hoc conversation groups, with new participants arriving and existing participants leaving.

SAA represents a paradigm shift in selective attention by introducing a comprehensive approach to constructing a complete conversational graph. This paradigm goes beyond merely localizing active speakers or identifying a focus of attention. Instead, it models complex, dynamic interactions and relationships between all participants in a conversational environment. SAA is the first model to explicitly address the multifaceted nature of group conversations, including:
1. Multi-Directional Interactions: Simultaneously modeling speaking and listening behaviors for all participants, not just those involving the camera wearer.
2. Parallel Conversations: Detecting and representing multiple concurrent conversations within the same group.
3. Temporal Evolution: Tracking formation, evolution, and dissolution of conversations over time.
4. Non-verbal Cues: Incorporating gaze direction, body language and spatial positioning into attention modeling.
5. Contextual Understanding: Considering a broader context of a scene and relationships between participants.

SAA addresses limitations of conventional approaches by employing a unified, multimodal approach that leverages advanced machine learning techniques to model a complete conversational ecosystem.

By addressing limitations of conventional approaches, SAA revolutionizes auditory attention modeling in smart glasses applications. SAA not only enhances the user's ability to navigate complex auditory environments but also provides new insights into group dynamics and social interactions in extended reality (XR) settings. The potential applications span professional, educational and social domains, transforming how people communicate and interact in XR environments.

Smart glasses represent the next frontier in wearable technology, offering potential for revolutionizing how people interact with digital information in their daily lives. A key aspect of this technology is the ability to augment human auditory perception, enabling users to selectively focus on specific speakers or audio sources in complex multi-speaker or multi-source acoustic environments. This capability has far-reaching implications for various applications. For professional settings, such as conferences and meetings, SAA enhances focus on speakers in noisy environments, facilitates real-time translation services for international conferences, and enables seamless note-taking and information retrieval during presentations. For educational environments, SAA improves attention to instructors or to specific group members during discussions, assists students with hearing impairments in classroom settings, and enables personalized learning experiences by focusing on relevant audio content. For social interactions, SAA facilitates better communication in crowded or noisy social settings, enhances experiences of social events by selectively focusing on desired conversations, and assists individuals with social anxiety by providing focused auditory input.

SAA enables assistive technology for individuals with hearing impairments by providing targeted audio enhancement for specific speakers, offering real-time captioning of focused conversations, and improving overall auditory comprehension in challenging acoustic environments.

In interactive digital environments, SAA enhances multi-participant experiences by improving communication and teamwork through focused audio streams, enabling context-aware audio prioritization, and facilitating enhanced spectator experiences. For hybrid collaborative environments, SAA facilitates focused interactions between participants, including human users and artificial intelligence (AI) agents, in multi-conversation settings spanning physical and virtual spaces.

In these advanced collaborative environments, SAA's capabilities expand beyond human-to-human interactions to include AI assistants as active participants in conversations. This expansion introduces new features to the system's functionality.

One such feature is AI integration. In this regard, SAA enables (i) automatic speech target selection for AI assistants, based on verbal and non-verbal cues, (ii) real-time adaptation of AI response to multi-conversation dynamics, and (iii) seamless switching between human and AI interlocutors in complex dialogues.

Another such feature is hybrid remote collaboration enhancement. In this regard, SAA enables (i) intelligent audio focus management for participants in different physical locations, (ii) spatial audio rendering for improved presence of remote participants, and (iii) dynamic prioritization of speakers based on conversation relevance and user attention.

Another such feature is non-verbal cue processing for AI interaction. In this regard, SAA enables (i) interpretation of gaze direction, body language, and gestures to guide AI assistant focus, (ii) integration of physiological data, such as EEG and heart rate, for enhanced understanding of user engagement, and (iii) adaptive response timing for AI assistants based on conversational rhythm and turn-taking cues.

Rotational data is input as yaw, pitch and roll values from each device's sensors. Feature extraction is applied to rotational data by calculating angular velocities and accelerations using quaternion differentiation, and by jerk calculation for smooth motion analysis. Gaze direction is estimated by computing forward vectors using rotation quaternions, projecting onto horizontal planes for 2D simplification, implementing threshold-based looking determination (e.g., 15° angle).

Another such feature is multi-modal conversation tracking. In this regard, SAA enables (i) simultaneous tracking of multiple conversation threads involving humans and AI agents, (ii) dynamic conversation graph updates to reflect the fluid nature of human-AI interactions, and (iii) intelligent interruption management for AI assistants in ongoing human conversations.

The ability to automatically focus on specific target speech based on both verbal and non-verbal cues is crucial in these multi-user/agent, multi-conversation environments. SAA's sophisticated algorithms for processing spatial, audio and physiological data enable it to navigate these complex scenarios, ensuring that both human users and AI assistants effectively participate in and contribute to dynamic, multi-threaded conversations.

The SAA model introduces a suite of groundbreaking technical innovations that collectively address challenges of real-time auditory attention modeling in smart glasses. SAA provides a multi-modal fusion architecture. SAA provides real-time optimization for wearable devices. SAA leverages different inferencing frameworks, for efficient model deployment on resource-constrained hardware. SAA implements INT8 quantization to reduce model size and improve inference speed. SAA employs advanced operator fusion techniques to combine multiple operations into optimized kernels. Custom memory management strategies minimize runtime allocation and fragmentation. Dynamic computation graphs adaptively scale model complexity based on input requirements. Asynchronous processing of modalities maximizes utilization of available computational resources. SAA provides graphics processing unit (GPU) acceleration for computationally intensive operations, such as attention mechanisms. An optimized data flow minimizes transfer latencies between processing stages. Workload-aware dynamic voltage and frequency scaling (DVFS) and selective computation techniques optimize power consumption.

SAA also provides adaptive temporal alignment. A sophisticated sliding window approach synchronizes heterogeneous data streams with varying sampling rates and latencies. Adaptive interpolation techniques ensure coherent integration of spatial, rotational and audio features. Specialized resampling methods preserve high-frequency information in audio data. Temporal warping algorithms handle asynchronous sensor updates.

SAA also provides modality-specific normalization. SAA applies custom normalization techniques for each input modality to handle diverse data scales. Dynamic batch normalization adapts to changing environmental conditions. Feature-wise normalization balances the contribution of different modalities. Multimodal statistics aggregation maintains consistent scaling across evolving scenarios.

SAA implements a novel conversation grouping model that determines real-time attention relationships between participants. The model processes multimodal inputs including spatial positions, audio signals and rotational data to generate dynamically updated attention probabilities. The system employs optimization criteria combined with temporal consistency constraints to ensure stable predictions across time. The model outputs confidence scores for each predicted conversation grouping, enabling robust decisions in dynamic environments.

These breakthrough innovations, seamlessly integrated within the SAA model, enable it to achieve state-of-the-art performance in real-time auditory attention modeling while operating within constraints of wearable devices. The unique combination of multimodal fusion, adaptive temporal processing, and hardware-specific optimizations sets the SAA model apart as a transformative technology for next-generation smart glasses.

SAA provides real-time attention prioritization in multi-participant environments using a flexible architecture that supports both local server processing and optional device-side processing when available. The system processes and integrates multimodal data, including spatial, auditory and rotational data, for accurate attention modeling. The processing system maintains robust performance across diverse scenarios and conversation patterns while adapting to dynamic environmental conditions.

The SAA model generates accurate conversation probability matrices. The system handles varying numbers of speakers, creating a dynamic, real-time updated P{i,j} matrix representing conversation likelihoods for unique participant pairs. For N participants, the system tracks N(N−1)/2 unique bidirectional relationships, achieving high accuracy in conversation grouping (precision and recall>0.9), and provides well-calibrated confidence scores for each predicted conversation pair.

The SAA model uses detection parameters optimized through experimental validation. The system's field of view parameters are configured based on acoustic scene experiments and attention modeling requirements. The model employs adaptive thresholds to manage attentional leakage to background conversations based on angular separation. Mutual gaze detection incorporates a confirmation threshold to distinguish between intentional and incidental eye contact. The system implements configurable temporal thresholds for distinguishing between accidental glances and intentional conversation initiation, with longer durations reducing false positives. The processing pipeline maintains update rates compatible with human auditory perception thresholds for spatial audio changes, while ensuring smooth transitions in audio stream management.

The SAA model introduces several groundbreaking innovations in the field of real-time auditory attention modeling for smart glasses, including (i) a transformer-based architecture for multimodal fusion implemented on a local processing system, with streaming to connected smart glasses, (ii) novel temporal alignment and adaptive normalization techniques, (iii) optimization techniques for efficient local processing and inferencing with latencies under 50 ms, (iv) sophisticated cross-validation and robustness testing methodologies, and (v) privacy-preserving and user-adaptive mechanisms. The system utilizes a high-performance local processor to handle input processing and model inference, while streaming results to the smart glasses. This distributed architecture enables processing of rich multimodal inputs while ensuring responsive user experience.

Regarding the transformer-based architecture, SAA efficiently processes and integrates spatial, rotational and audio features, achieves state-of-the-art performance in conversation grouping tasks, and demonstrates robust generalization across diverse scenarios.

Regarding normalization, SAA enables seamless integration of heterogeneous data streams, adapts to varying environmental conditions and user behaviors, and improves model stability and generalization capabilities.

The system achieves processing latency of ˜120 ms per frame, utilizing efficient model deployment frameworks and implementing advanced quantization and operator fusion techniques.

Regarding cross-validation and robustness, SAA ensures consistent performance across different datasets and scenarios, demonstrates resilience to environmental noise and speaker movements, and provides a comprehensive framework for evaluating attention models.

Regarding privacy, SAA implements on-device processing to minimize data transmission, uses personalization techniques for improved user experience, and uses federated learning approaches.

The SAA model has far-reaching implications for multi-participant communication environments, including (i) enhanced auditory focus in complex environments, (ii) intuitive and responsive attention switching, (iii) improved accessibility for individuals with hearing impairments, and (iv) enabling new applications in mixed physical and virtual environments.

Regarding auditory focus, SAA enables users to selectively focus on desired speakers in noisy settings, improves communication efficiency in professional and social contexts, and enhances overall user experience in extended reality applications.

Regarding attention switching, SAA provides seamless transitions between different speakers or audio sources, adapts to user intentions and environmental changes in real-time, and facilitates more natural interactions in multi-speaker scenarios.

Regarding accessibility, SAA offers targeted audio enhancement for specific speakers, enables better understanding in challenging acoustic environments, and integrates with existing assistive hearing technologies.

Regarding new applications in mixed reality environments, SAA supports context-aware information delivery based on user attention, enhances immersion in interactive digital experiences, and facilitates new forms of collaborative work across physical and virtual spaces.

There is thus provided in accordance with an embodiment of the present invention apparatus for selective auditory attention in multi-participant environments, wherein each of a plurality of wearable devices or a combination thereof receives input audio streams from participants and transmits an output audio stream to participants, each input audio stream being generated from the output audio streams, and wherein one or more sensors capture participant interaction data, the apparatus including a feature extractor extracting multimodal features from the participant interaction data, a set of machine learning models, namely, an attention neural network, determining attention relationships between participants based on the extracted features, and computing attention probabilities for each pair of participants, based on the attention relationships, and an adaptive audio gain controller dynamically controlling the input audio gain received by each wearable device or combination of wearable devices based on the computed attention probabilities.

Additionally, the participants include humans and artificial intelligence (AI) assistants.

Further, the participant interaction data includes at least one of spatial positioning data, head orientation data, body movement data, gaze direction data, audio activity data, EEG data and biometric data.

Yet further, the adaptive audio gain controller dynamically adjusts relative audio levels of different output audio streams based on the attention probabilities.

Moreover, the attention neural network ranks each participant according to his state of attention, based on the participants' interaction data.

Additionally, the apparatus includes a wearable device controller adjusting visual elements on wearable devices based on the participants' states of attention.

Further, the apparatus includes a wearable device controller providing haptic feedback via wearable devices in response to changes in one or more participants' states of attention.

There is also provided in accordance with an embodiment of the present invention a method for selective audio attention in multi-participant environments, each participant wearing a device or a combination of devices that receives input audio streams from other participants and that transmits an output audio stream to other participants, the method including receiving participant interaction data from one or more sensors, determining attention relationships between participants based on the participant interaction data, computing attention probabilities for each pair of participants, based on the attention relationships, and dynamically controlling the input audio gain received by each wearable device based on the computed attention probabilities.

Additionally, the method includes detecting sustained interaction periods based on the attention probabilities, and identifying conversation groupings of participants based on the sustained interaction periods.

Further, the dynamically controlling includes applying gain levels to received audio streams commensurate with the attention probabilities, to attenuate an audio stream arriving from a first participant received by a second participant when the attention probability for the pair consisting of the first and the second participant is a low probability, and to amplify the audio output stream when the attention probability of the pair is a high probability.

Yet further, the method includes classifying each participant according to his state of attention, based on the participant interaction data.

Moreover, the method includes adjusting visual elements on wearable devices based on the participants' states of attention.

Additionally, the method includes providing haptic feedback via wearable devices in response to changes in one or more participants' states of attention.

There is also provided in accordance with an embodiment of the present invention a system for attention-based audio control for a plurality of participants, each participant wearing a device or a combination of devices that receives input audio streams from other participants and that transmits an output audio stream to other participants, the system including distributed receivers for receiving multimodal participant interaction data from one or more sensors, attention neural networks for determining attention patterns based on the multimodal participant interaction data, and distributed adaptive audio gain controllers for modifying audio signal gain from each device or combination of devices, based on the attention patterns.

Additionally, the system includes memory storing historical attention pattern data, and the adaptive audio gain controllers adapt the audio outputs based on the historical attention pattern data.

Further, the machine learning models process the multimodal participant input data, and to determine attention relationships and predict changes in attention patterns.

Yet further, in one embodiment, the machine learning models include a neural network to process the multimodal participant input data, to determine attention relationships, and to predict changes in attention patterns, the neural network includes an input stage ingesting raw sensor data from multiple streams of spatial, rotational, audio and gaze inputs, and priority-based queueing synchronizing the streams.

Moreover, the neural network includes a processing stage extracting features from the raw sensor data, running the extracted features through a transformer network, and inferring the attention patterns.

Additionally, the neural network includes an output stage generating predictions, updating a conversational graph, and formatting results for visualization, the conversation graph being a graph with nodes representing the participants and edges connecting participants paying attention to one another, based on the attention patterns.

Further, the system includes a trainer training the neural network using scenarios including free-flow group conversations, one-to-one discussions, group presentations, transitions, and interruptions and overlaps.

There is also provided in accordance with an embodiment of the present invention a system for selective auditory attention in multi-participant environments, including a plurality of wearable devices configured to output audio, one or more sensors configured to capture participant interaction data, and a processor configured to determine attention relationships between participants based on the participant interaction data, generate a probability matrix representing likely attention patterns based on the attention relationships, and dynamically modify the output audio based on the likely attention patterns.

Additionally, the participant interaction data includes at least one spatial positioning data, head orientation data; gaze direction data, audio activity data and biometric data.

Further, the dynamically modifying includes adjusting relative audio levels between different audio streams, maintaining awareness of non-primary audio streams, and transitioning audio levels based on changes in the likely attention pattern.

There is also provided in accordance with an embodiment of the present invention a method for managing audio in multi-participant environments, including receiving participant interaction data from one or more sensors, processing the interaction data to determine attention patterns, and adjusting audio output based on the determined attention patterns.

Additionally, the processing includes analyzing temporal relationships between participants, detecting sustained interaction periods, and identifying conversation groupings.

There is also provided in accordance with an embodiment of the present invention a system for attention-based audio management, including input means for receiving participant interaction data, processing means for determining attention patterns based on the participant interaction data, and output means for modifying audio based on the attention patterns.

Additionally, the system further includes memory storing historical attention pattern data, and processing logic to adapt audio modification based on historical patterns.

Further, the processor employs machine learning to process multimodal input data, to determine attention relationships, and to predict attention pattern changes.

There is also provided in accordance with an embodiment of the present invention a method for attention-based audio processing, including capturing interaction data from multiple participants, computing attention probabilities between participants based on the interaction data, and adjusting audio streams based on the attention probabilities.

There is also provided in accordance with an embodiment of the present invention a non-transitory computer-readable medium storing instructions that, when executed, cause a processor to process participant interaction data, determine attention relationships based on the interaction data, and control audio output based on the attention relationships.

### Multimodal Attention Modeling Architecture

A method for modeling attention patterns in multi-participant environments uses a machine learning architecture that processes sensory inputs in real-time to determine attention relationships between participants. The method uniquely processes inputs from multiple co-located and remote participants wearing sensor-enabled devices, adaptively weighting different input modalities to generate robust attention predictions.

There is thus provided in accordance with an embodiment of the present invention a method for attention modeling in multi-participant environments, including processing real-time sensory inputs from multiple co-located and remote participants, and generating participant attention states indicating which participants are paying attention to one another.

Additionally, the method includes modality-specific processing for different sensor inputs.

Further, the method includes cross-modal integration between different sensor inputs.

Yet further, the method includes processing of temporal-spatial relationships between participants.

Moreover, the method includes multi-level attention processing.

Additionally, the method includes hierarchical processing with local, regional and global attention spans.

Further, the method includes adaptive weighting of different input modalities using learned importance scores.

Yet further, the method includes dynamic processing window adjustment based on conversation dynamics.

Moreover, the method optimizes for binary attention state prediction.

Additionally, the method maintains temporal consistency in attention predictions.

Further, the method employs sparsity constraints to focus on relevant attention patterns.

### Dynamic Conversation Graph Generation System

A method for dynamic conversation graph generation builds a real-time representation of social interactions by fusing multi-modal sensor data to compute dynamic edge weights. The method uses recurrent connections and momentum-based updates to preserve the graph state over time and can handle varying numbers of participants and sub-group formations.

There is thus provided in accordance with an embodiment of the present invention a method for dynamic conversation graph generation, including receiving as input multimodal sensor data, and building a real-time representation of dynamic social interactions having varying numbers of participants and sub-group formations over time, in the form of a graph with dynamic edge weights.

Additionally, the method further includes computing edge weights using sigmoid-normalized attention scores.

Further, the method further includes computing edge weights using temporal smoothing with an exponential moving average.

Yet further, the method further includes preserving a graph state using recurrent connections.

Moreover, the method further includes thresholding hysteresis for state changes.

Additionally, the method further includes applying mel-frequency cepstral (MFC) correlation on audio input.

Further, the method further includes applying inverse square distance weighting on spatial input.

Yet further, the method further includes applying normalized intersection duration to gaze input.

### Distributed Processing Architecture for Attention Modeling

A method for distributed processing enables real-time attention modeling across multiple participants by implementing a two-tier architecture: a local processing server that performs primary model computations and connected participant devices that handle sensor data collection and audio output. The method employs efficient data streaming protocols between the server and devices while maintaining low-latency audio adjustments.

There is thus provided in accordance with an embodiment of the present invention a method for distributed attention processing, including receiving sensor data streams from multiple participant devices to a local processing server, performing attention modeling computations on the server, and streaming attention-based audio adjustment parameters back to the devices.

Additionally, the method includes sliding window processing for real-time sensor data integration.

Further, the method manages multiple concurrent data streams from participant devices.

Yet further, the method synchronizes data processing across server and device components.

Moreover, the method prioritizes processing based on conversation dynamics.

Additionally, the method implements efficient data streaming between server and devices.

Further, the method maintains temporal alignment between server processing and device outputs.

Yet further, the method provides failover handling for connection interruptions.

### Multi-Participant Conversation State Detection

A method for multi-participant conversation state detection models group dynamics and interpersonal engagement using audio, spatial, and gaze features. The method identifies varying levels of engagement among participants, from active participation to disengagement, by using weighted positioning, spatial clustering, and participation rate monitoring.

There is thus provided in accordance with an embodiment of the present invention a method for multi-participant conversation detection, including receiving as input audio, spatial and gaze features, and identifying conversation states including active engagement and disengagement patterns based on the received input.

Additionally, the identifying includes using mutual gaze pattern analysis.

Further, the identifying includes detecting even turn distributions.

Yet further, the identifying includes scoring audio separation confidence.

Moreover, the identifying includes scoring engagement using gaze and audio features.

Additionally, the identifying includes monitoring participation rate.

Further the identification includes predicting re-engagement.

Yet further, the identifying includes monitoring state transition using a transition probability matrix with hysteresis.

Moreover, the identifying includes applying confidence thresholds for state transitions.

Additionally, the identifying includes applying multi-factor validation using one or more of (i) an audio participation ratio, (ii) a gaze interaction frequency, and (iii) spatial positioning stability.

Further, the identifying includes analyzing turn-taking patterns.

Yet further, the identifying includes applying feature-based confidence scoring.

### Multi-Participant Voice Activity Detection System

A method for voice activity detection for multi-participant environments utilizes distributed microphone arrays across multiple participant devices to improve detection accuracy. The method leverages knowledge of participant locations and their respective audio streams to perform targeted voice separation and noise reduction, enabling more accurate speaker detection in co-located conversations.

There is thus provided in accordance with an embodiment of the present invention a method for voice activity detection in multi-participant environments, including receiving audio streams from multiple participant devices, determining voice direction. determining spatial relationships between participants, performing cross-stream audio analysis to isolate individual speakers, and detecting voice activity with environmental adaptation.

Additionally, the method performs cross-device audio stream alignment.

Further, the method implements selective audio stream subtraction based on participant positions.

Yet further, the method applies spatial filtering based on known participant locations.

Moreover, the method performs confidence scoring incorporating multi-stream analysis.

Additionally, the method adapts to changing spatial relationships between participants.

Further, the method maintains speaker identification across multiple audio streams.

Yet further, the method adjusts processing based on participant movement.

Moreover, the method adapts to changes in the acoustic environment.

Spatial Audio Processing System with Motion-Compensated Beamforming

A method for spatial audio processing leverages distributed sensor data from multiple co-located participants to construct real-time acoustic models of shared spaces. The method combines point cloud data from multiple participant devices to create a comprehensive spatial map, enabling accurate modeling of room acoustics and sound propagation patterns for enhanced audio rendering.

There is thus provided in accordance with an embodiment of the present invention a method for spatial audio processing in multi-participant environments, including receiving point cloud data and audio streams from multiple co-located participant devices, constructing a unified spatial-acoustic model of the shared environment, and rendering spatially-aware audio based on the combined environmental model.

Additionally, the method fuses point cloud data from multiple participant viewpoints.

Further, the method dynamically updates acoustic models as participants move through the space.

Yet further, the method identifies acoustic surfaces and materials from combined sensor data.

Moreover, the method generates room impulse responses based on the unified spatial model.

Additionally, the method adapts audio rendering based on relative participant positions within the modeled space.

Further, the method maintains acoustic model coherence across multiple devices.

Yet further, the method updates acoustic properties based on real-time environmental changes.

Moreover, the method incorporates participant movement into acoustic calculations.

Additionally, the method generates personalized acoustic renderings for each participant based on their position within the shared model.

Further, the method maintains temporal synchronization of acoustic updates across participant devices.

Multi-Stream Source Separation System with Cross-Modal Enhancement

A method for multi-stream source separation leverages cross-modal cues like lip movements and speaker location to enhance audio processing. The method fuses visual and spatial information to improve quality of separated audio streams.

There is thus provided in accordance with an embodiment of the present invention a method for improving quality of separated audio streams from participants of a group conversation, including receiving combined audio streams, visual data and spatial data of the participants in real time, identifying lip movements and speaker locations of the participants based on the received visual and spatial data, and separating the audio streams including fusing the visual and spatial information based on the identified lip movements and speaker locations.

Additionally, the method further includes encoding the audio streams prior to the separation, and decoding the separated audio streams subsequent to the separation.

Further, the identifying includes correlating visual lip movements and weighting spatial position.

### Multi-Device Audio-Based Spatial Tracking System

A method for real-time multi-participant tracking dynamically calibrates a shared 3D coordinate frame using data from distributed sensor devices. The method employs Kalman filtering and adaptive reference frame adjustment to maintain spatial coherence across multiple participants.

There is thus provided in accordance with an embodiment of the present invention a method for participant positioning in multi-participant environments, including using distributed audio devices to approximate relative participant positions through audio propagation analysis, combining audio-based positioning with additional sensor data for improved spatial awareness, maintaining dynamic spatial relationships between participants, and adapting position estimates based on attention patterns and conversation dynamics.

Additionally, the audio propagation analysis includes processing time-of-arrival differences between multiple microphones, analyzing audio signal strength across different devices, estimating relative distances based on sound propagation characteristics, and Triangulating positions using multiple audio sources and receivers.

Further, the method maintains temporal synchronization by implementing device synchronization protocols, applying cross-device time synchronization, applying continuous timing corrections, managing distributed audio stream alignment, and maintaining coherent temporal relationships between audio sources.

Yet further, the method enhances position estimates by filtering noise from audio-based position estimates, integrating complementary sensor data when available, applying smoothing to position updates, and adapting to environmental acoustic conditions.

Moreover, the method manages dynamic participant relationships by tracking relative movement between participants, updating spatial models based on conversation group dynamics, maintaining consistent spatial relationships during participant movement, and adapting to changes in group formation and dissolution.

### Gaze-Based Attention System

A method for gaze-based attention accurately tracks eye movements and infers mutual gaze patterns to assess social engagement. The method uses ray casting and saliency modeling to identify the most relevant conversation participants based on gaze direction and fixation. There is thus provided in accordance with an embodiment of the present invention a method for assessing social engagement, including tracking eye movements of multiple participants in a group conversation, inferring mutual gaze patterns among the participants based on the tracked eye movements, and identifying most relevant conversation participants based on gaze direction and fixation.

Additionally, the identifying includes ray casting.

Further, the ray casting includes polynomial regression.

Yet further, the ray casting includes intersection detection using a spherical head model and ray sphere intersection.

Moreover, the tracking uses 4 LEDs per eye and synchronized strobing.

Additionally, the tracking includes detecting blinks.

Further, the inferring includes assessing gaze stability.

Yet further, the inferring includes rejecting false positives.

### Hierarchical Social Focus Point Computation System

A method computes multiple levels of dynamic social focus points in multi-participant environments. The method identifies and tracks focal points at both the individual conversation group level and the overall participant gathering level by fusing weighted contributions from participants' positions, gaze, and movement patterns. The method maintains concurrent tracking of multiple conversation-specific focal points while simultaneously computing aggregate social focus metrics for the entire group.

There is thus provided in accordance with an embodiment of the present invention a method for tracking evolving social focus points in multi-participant environments, including computing conversation-specific focal points for distinct conversation groups using weighted averages of participant positions, speaking patterns, gaze attention, and movement dynamics, computing aggregate social focus metrics across all participants; and maintaining relationships between conversation-specific and aggregate focal points.

Additionally, the method includes detecting and tracking multiple concurrent conversation groups.

Further, the method includes adapting to dynamic formation and dissolution of conversation groups.

Yet further, the method includes maintaining stability across multiple focus points.

Multi-Mode Feature Extraction with Adaptive Importance Sampling

A method for unified multi-modal feature extraction pipeline dynamically adjusts the importance of different sensor modalities based on environmental conditions and task requirements. The method employs adaptive normalization techniques to ensure consistent feature scaling across evolving scenarios.

There is thus provided in accordance with an embodiment of the present invention a method for dynamically adjusting importance of sensor modalities for a plurality of sensors monitoring a group conversation, in performance of a task relating to the group participants, including extracting audio features, spatial features and gaze features from audio, spatial and gaze sensors, respectively, normalizing the extracted audio and spatial features, and dynamically assigning importance weights to the normalized audio features, to the normalized spatial features, and to the gaze features, based on environmental conditions or the task requirements.

Additionally, the audio features include one or more of mel-frequency cepstral coefficient, spectral flux, pitch, and zero-crossing rate.

Further the spatial features include one or more of positions, velocities and accelerations of participants, and inter-participant distances between participants.

Yet further, the gaze features include one or more of direction, fixation, saccade velocity and attention.

Moreover, normalizing the extracted audio features includes at least one of per-channel energy normalization, cepstral mean normalization, and dynamic range compression.

Additionally, normalizing the extracted spatial features includes at least one of min-max scaling with adaptive bounds, quaternion normalization for rotations, and distance normalization.

Further, dynamically assigning is based on at least one of signal quality and user interaction patterns.

Cross-Modal Integration with Dynamic Attention Routing

A method for cross-modal integration uses attention-based fusion and temporal consistency models to combine heterogeneous sensor inputs. The method adaptively weights the contributions of different modalities based on the current context.

There is thus provided in accordance with an embodiment of the present invention a method for integrating cross-modal sensor inputs for a plurality of sensors monitoring a group conversation for a plurality of participants, including applying preliminary fusing to heterogenous sensor inputs using modality-specific gating, identifying attention features of the participants, and applying attention-based post fusing to the sensor inputs.

Additionally, applying preliminary fusing includes concatenating features with alignment.

Further, applying preliminary fusing includes reducing dimension using principal component analysis.

Yet further, the identifying uses modality-specific attention masks.

Moreover, the identifying includes computing cross-modal attention to the post fused sensor inputs.

Additionally, applying attention-based post fusing includes using a weighted combination of predictions.

Further, applying attention-based post fusing includes applying confidence-based fusion.

Yet further, the method includes applying temporal consistency to the post-fused sensor inputs.

Moreover, applying temporal consistency includes detecting change points.

Additionally, applying temporal consistency includes validating state transitions.

Further, applying temporal consistency includes exponential smoothing.

Environmental Context Analysis with Multi-Dimensional Scene Understanding

A method for environmental context analysis builds a multi-dimensional understanding of a social setting by assessing acoustics, ambient conditions, and scene complexity. The method tracks room properties, noise levels, and participant density to optimize the attention modeling process.

There is thus provided in accordance with an embodiment of the present invention a method for context analysis of a plurality of participants conversing in a room, including tracking room properties and noise levels, and assessing acoustics, ambient conditions, and scene complexity based on said tracking.

Additionally, assessing acoustics includes detecting early reflections.

Further, assessing acoustics comprises estimating room size.

Yet further, assessing acoustics includes classifying surface material.

Moreover, assessing ambient conditions includes tracking background noise level.

Additionally, assessing ambient conditions includes detecting movement activity.

Further, assessing scene complexity includes calculating participant density.

Yet further, assessing scene complexity comprises detecting conversation clutter.

Moreover, assessing scene complexity includes tracking dynamic obstacles.

Accelerated Neural Processing with Dynamic Operator Fusion for Extended Reality

A method for accelerating neural processing that custom CUDA kernels and operator fusion to optimize the performance of attention-based models on resource-constrained hardware.

There is thus provided in accordance with an embodiment of the present invention a method for accelerating neural processing on resource-constrained hardware, including applying special kernels and operator fusion, and managing memory to optimize performance of attention-based models.

Additionally, the special kernels include fused multi-head attention kernels.

Further, applying special kernels includes optimizing batch processing.

Yet further, applying special kernels includes utilizing shared memory.

Moreover, applying special kernels includes coarsening threads.

Additionally, applying operator fusion includes applying attention-dropout fusion.

Further, applying operator fusion includes computing custom gradients.

Yet further, the managing includes allocating a tensor memory pool.

Moreover, the managing includes optimizing cache by transforming data layout.

Additionally, the managing includes optimizing cache by pre-fetching.

Further, the managing includes optimizing cache by cache line alignment.

Adaptive Precision Computation System with Dynamic Range Optimization

An adaptive precision computing method dynamically adjusts numerical representations to balance accuracy and efficiency for different model components. The method employs quantization-aware training and mixed-precision techniques to reduce model size and improve inference speed.

There is thus provided in accordance with an embodiment of the present invention a method for computation with adaptive precision for a model with components, including training model datasets to obtain quantization-aware training, and applying mixed precision to reduce model size and improve inference speed.

Additionally, the training includes applying layer-specific quantization with attention layers, convolution layers, fully connected layers and activation layers.

Further, the applying includes adjusting dynamic range.

Yet further, the adjusting includes per-channel scaling.

Moreover, the adjusting includes tracking activation statistics.

Additionally, the training includes generating fake quantization nodes.

Further, the training includes gradient scaling.

Yet further, the training includes adapting a loss function.

Moreover, the method further includes calibrating dynamic range.

Additionally, the method further includes aligning a cross-layer range.

Further, the method further includes selecting representative datasets.

Power-Aware Computation with Predictive Load Management

A power-aware computing method performs predictive load management and selective computation to optimize energy usage on wearable devices. The method leverages DVFS and task prioritization to maintain real-time performance under varying workloads.

There is thus provided in accordance with an embodiment of the present invention a method for power-aware computation to optimize energy usage on wearable devices, including applying dynamic voltage and frequency scaling, managing load, and applying selective computation.

Additionally, in accordance with an embodiment of the present invention applying frequency scaling) includes temperature-aware adjustment.

Further, applying frequency scaling includes workload prediction.

Yet further applying dynamic voltage includes timing power state transition.

Moreover, applying dynamic voltage includes separating CPU and GPU domains.

Additionally, applying selective computation includes task prioritization using critical path analysis.

Further, applying selective computation includes task prioritization using deadline-driven scheduling.

Yet further, applying selective computation includes task prioritization using quality-power tradeoffs.

Moreover, applying selective computation includes resource allocation using memory bandwidth management.

Additionally, applying selective computation includes resource allocation using CPU core assignment.

Further, applying selective computation includes resource allocation using GPU utilization control.

### Privacy-Preserving Personalized Attention System for Social Interactions

A method for privacy-preserving personalized attention adapts to individual user patterns while preserving their data. The method implements on-device learning and differential privacy techniques to enable user-specific customization without compromising privacy.

There is thus provided in accordance with an embodiment of the present invention a method for personalized attention that preserves privacy, including implementing on-device learning, implementing differential privacy, and providing user-specific customization without compromising privacy.

Additionally, implementing on-device learning includes incremental updating using a feature extraction buffer.

Further, implementing on-device learning includes incremental updating using gradient accumulation.

Yet further, implementing on-device learning includes incremental updating using a parameter update frequency.

Moreover, implementing on-device learning includes model adapting using user-specific layer fine-tuning.

Additionally, implementing on-device learning incudes model adapting using attention weight adaptation.

Further, implementing on-device learning includes model adapting using bias term adjustment.

Yet further, implementing differential privacy includes injecting noise.

Moreover, implementing differential privacy includes privacy budget management.

Additionally, implementing differential privacy includes sensitivity analysis.

Further, implementing differential privacy includes secure storage using encrypted parameters.

Yet further, implementing differential privacy includes secure storage using a secure execution environment.

Moreover, implementing differential privacy includes secure storage using access control.

On-Device Processing System with Dynamic Data Minimization

An on-device processing method dynamically minimizes data exposure by selectively computing features and managing secure enclaves. The method employs encryption, access control, and data retention policies to ensure privacy-preserving operation.

There is thus provided in accordance with an embodiment of the present invention a method for on-device processing that preserves privacy, including minimizing data exposure including selectively computing features, and managing secure enclaves.

Additionally, the method further includes using a secure processing pipeline with a trust-zone based execution environment.

Further, the method further includes using a secure processing pipeline with secure boot verification.

Yet further, the method further includes using a secure processing pipeline with runtime integrity checking.

Moreover the method further includes using a secure processing pipeline with memory encryption.

Additionally, selectively computing features includes feature extraction security using raw data sanitization.

Further, selectively computing features includes feature extraction security using feature anonymization.

Yet further, selectively computing features includes feature extraction security using a minimal persistence strategy.

Moreover, the method further includes minimizing data using temporal data retention limits.

Additionally, the method further includes minimizing data using selective feature computation.

Further, the method further includes minimizing data using privacy-aware caching.

Yet further, the method of further includes implementing processing boundaries using secure/non-secure world separation.

Moreover, the method further includes implementing processing boundaries using data flow control.

Additionally, the method further includes implementing processing boundaries using resource isolation.

Further, the method further includes implementing memory protection using secure memory regions.

Yet further, the method further includes implementing memory protection using access control.

Moreover, the method further includes implementing memory protection using secure DMA channels.

Distributed Social Interaction System with Anonymous State Sharing

A method for distributed social interaction enables anonymous state sharing and privacy-preserving analytics. The method uses end-to-end encryption, secure broadcast protocols, and differential privacy techniques to facilitate collaboration while protecting user data.

There is thus provided in accordance with an embodiment of the present invention a method for social interaction to facilitate collaboration while protecting user data, including applying end-to-end encryption, applying secure broadcast protocols, and applying differential privacy.

Additionally, the end-to-end encryption includes perfect forward secrecy.

Further, applying secure broadcast protocols includes state synchronization and verification.

Yet further, the secure broadcast protocols include aggregation protocols.

Moreover, applying differential privacy includes randomizing responses.

Additionally, applying differential privacy includes secure logging using encrypted audit trails.

Further, applying differential privacy includes secure logging using selective logging policies.

Yet further, applying differential privacy incudes secure logging using retention management.

Dynamic Privacy Control with Context-Aware Consent Management

A method for dynamic privacy control provides granular permissions and context-aware consent management. The method allows users to dynamically adjust their privacy preferences based on the current scenario and activity.

There is thus provided in accordance with an embodiment of the present invention a method for dynamic privacy control including providing granular permissions, and providing context-aware consent management, and dynamically adjusting privacy preferences based on a user's current scenario and activity.

Additionally, the granular permissions include feature-level permissions.

Further, providing context-aware consent management includes providing a user interface with interactive permission management.

Yet further, providing context-aware consent management includes providing a user interface with real-time status indicators.

Moreover, providing context-aware consent management includes providing a user interface with privacy impact visualization.

Additionally, the context-aware consent management includes context-aware access control.

Further, the context-aware consent management includes temporal access limitations.

Yet further, the dynamically adjusting includes contextual adaptation of consent using environment-based adjustments.

Moreover, the dynamically adjusting includes contextual adaptation of consent using activity-specific permissions.

Additionally, the dynamically adjusting includes contextual adaptation of consent using social context awareness.

Further, the dynamically adjusting includes consent verification using periodic revalidation.

Yet further, the dynamically adjusting comprises consent verification comprising analyzing usage patterns.

Moreover, the dynamically adjusting includes consent verification comprising detecting anomalies.

Cross-Platform Social Interaction with Real-Time State Synchronization

A method for cross-platform social interaction enables real-time state synchronization across applications. The method defines standardized data formats and protocols to facilitate the integration of attention-aware features into diverse AR/VR applications.

There is thus provided an accordance with an embodiment of the present invention a method for social interaction with real-time state synchronization, including standardizing data formats, and integrating attention-aware features into augmented reality/virtual reality applications.

Additionally, the standardizing uses a schema definition with extensible types.

Further, the standardizing uses a protocol specification with a binary serialization format.

Yet further, the integrating uses real-time hooking using an event pipeline with priority-based routing.

Moreover, the integrating uses real-time hooking using an event pipeline with load balancing.

Additionally, the integrating uses real-time hooking using an event pipeline with latency monitoring.

Further, the integrating uses an integration interface using web socket connections.

Multi-Application Resource Orchestration System with Dynamic Priority Management

A method for multi-application resource orchestration dynamically manages priority-based allocation of shared computing resources. The method monitors performance metrics and adjusts resource quotas to optimize the overall user experience across concurrent applications.

There is thus provided in accordance with an embodiment of the present invention a method for multi-application resource orchestration, including dynamically managing priority-based allocation of shared computing resources, monitoring performance metrics, and adjusting resource quotas to optimize overall user experience across concurrent applications.

Additionally, the dynamically managing applies a priority system based on application ranking.

Further, the dynamically managing applies a priority system based on dynamic priority adjustment.

Yet further, the dynamically managing applies a priority system based on resource quotas.

Moreover, the dynamically managing applies a policy engine using rule-based decision making.

Additionally, the dynamically managing applies a policy engine using policy conflict resolution.

Further, the dynamically managing applies a policy engine using resource reservation.

Yet further, the adjusting includes resource sharing using memory pooling.

Moreover, the adjusting includes resource sharing using compute unit sharing.

Additionally, the adjusting include resource sharing using power budget allocation.

Further, the monitoring includes latency tracking.

Yet further, the monitoring includes monitoring performance of resource utilization.

Additionally, the monitoring includes monitoring performance using quality metrics.

Distributed Social Interaction Processing with Adaptive Load Balancing

A distributed social interaction processing method adaptively load-balances workloads between edge and cloud computing resources. The method monitors network conditions and latency to dynamically offload computation and maintain responsive performance.

There is thus provided in accordance with an embodiment of the present invention a method for distributed social interaction processing, including monitoring network conditions and latency to dynamically offload computation, and adaptively balancing workloads between edge and cloud computing resources.

Additionally, the adaptively balancing includes distributing tasks by partitioning workloads.

Further, the adaptively balancing includes distributing tasks by dynamic offloading.

Yet further, the adaptively balancing includes distributing tasks by compensating for jitter.

Moreover, the adaptively balancing includes optimizing bandwidth using data compression.

Additionally, the adaptively balancing includes multi-level caching.

Further, the adaptively balancing includes using a cache coherency protocol.

Predictive Social Interaction with Multi-Modal State Anticipation

A method for predictive social interaction anticipates the evolution of conversation flows and proactively allocates computational resources. The method leverages long short-term memories (LSTMs) and Markov chain models to forecast conversation state changes and optimize resource utilization

There is thus provided in accordance with an embodiment of the present invention a method for predictive social interaction, including forecasting conversation state changes, optimizing resource allocation, and proactively allocating computational resources.

Additionally, the forecasting includes modeling conversation using LSTM-based sequence prediction.

Further, the forecasting includes modeling conversation using speaker turn prediction.

Yet further, the forecasting includes modeling conversation using topic evolution tracking.

Moreover, the forecasting includes state prediction using Markov chain modeling.

Additionally, the forecasting includes state prediction using confident estimation.

Further, the forecasting includes state prediction using multiple hypothesis tracking.

Yet further, the optimizing includes predictive loading using model pre-warning.

Moreover, the optimizing includes predictive loading using resource prefetching.

Additionally, the optimizing includes predictive loading using state preparation.

Further, the optimizing includes adapting by tracking prediction accuracy.

Yet further, the optimizing includes adapting by model adjustment.

Moreover, the optimizing includes adapting by resource optimization.

Real-Time Semantic Understanding with Dynamic Context Adaptation

A method for real-time semantic understanding dynamically adapts to conversational context to provide relevant insights. The method employs keyword detection, topic tracking, and relevance assessment to identify the most pertinent information for the user's current focus.

There is thus provided in accordance with an embodiment of the present invention a method for semantic understanding of a user's speech, including detecting keywords, tracking topics, processing semantics, and assessing relevance to identify the most pertinent information for a user's current focus.

Additionally, the detecting includes phoneme-based recognition.

Further, the detecting includes using a keyword spotting network.

Yet further, the detecting includes scoring confidence.

Moreover, the tracking includes dynamic topic modeling.

Additionally, the tracking includes managing context windows.

Further, the tracking includes scoring relevance.

Yet further, the processing includes extracting features.

Moreover, the processing includes word embedding computation.

Additionally, the assessing includes multi-factor scoring.

Further, the assessing includes temporal correlation.

Yet further, the assessing includes user interest modeling.

Universal Social Interaction Analysis with Cross-Cultural Adaptation

A method for multi-language social interaction analysis enables cross-cultural adaptation through language-independent feature extraction. The method uses shared encoder layers and language-specific decoders to handle diverse speaking styles and cultural contexts.

There is thus provided in accordance with an embodiment of the present invention a method for multi-lingual social interaction analysis, including extracting features, adapting culture, sharing encoder layers, and language-specific decoding to handle diverse speaking styles and cultural contexts.

Additionally, the extracting includes recognizing universal phones.

Further, the extracting includes language-independent prosody.

Yet further, the extracting includes cross-lingual embedding.

Moreover, the extracting uses a model architecture with shared encoding layers.

Additionally, the extracting uses a model architecture with language-specific decoders.

Further, the extracting uses a model architecture with attention pooling.

Yet further, the adapting includes context modeling using cultural feature extraction.

Moreover, the adapting includes context modeling using interaction pattern recognition.

Additionally, the adapting includes context modeling using behavioral adaptation.

Further, the adapting includes dynamic adjusting using style transfer.

Yet further, the adapting includes dynamic adjusting using protocol adaptation.

Moreover, the adapting includes dynamic adjusting using feedback incorporation.

Extended Reality Enhancement with Social Context Integration

A method for enhancing extended reality integrates social context to provide seamless and socially-aware augmented experiences. The method fuses visual, spatial, and conversational data to enable intelligent content placement, gesture recognition, and haptic feedback in shared AR/VR environments.

There is thus provided in accordance with an embodiment of the present invention a method for enhancing extended reality, including processing visual data, fusing the visual data with spatial and conversational data, recognizing gestures, and using haptic feedback in shared augmented or virtual reality environments.

Additionally, the processing includes overlay management using depth-aware placement.

Further, the processing includes overlay management with occlusion handling.

Yet further, the processing includes overlay management using visual attention tracking.

Moreover, the processing includes content placement using saliency mapping.

Additionally, the processing includes content placement using gaze prediction.

Further, the processing includes content placement using collision avoidance.

Yet further, the fusing includes synchronizing using audio-visual alignment.

Moreover, the fusing includes synchronizing using temporal correlation.

Additionally, the fusing includes synchronizing using state consistency.

Further, the fusing uses an interaction model including gesture recognition.

Yet further, the fusing uses an interaction model including voice commands.

Moreover, the fusing uses an interaction model including gaze interaction.

Additionally, the fusing uses an interaction model including haptic feedback.

### BRIEF DESCRIPTION OF THE DRAWINGS

The present invention will be more fully understood and appreciated from the following detailed description, taken in conjunction with the drawings in which:

FIG. 1 is a prior art diagram of a “cocktail party effect”;

FIG. 2 is a simplified diagram of attention patterns within the cocktail party shown in FIG. 1, in accordance with an embodiment of the present invention;

FIGS. 3-5 are simplified illustrations of various conversations to which selective auditory attention (SAA) may be applied, in accordance with embodiments of the present invention;

FIG. 6 is a simplified block diagram of apparatus for selective auditory attention in multi-participant environments, in accordance with an embodiment of the present invention;

FIG. 7 is a simplified flowchart of a method for selective audio attention in multi-participant environments, in accordance with an embodiment of the present invention;

FIG. 8 is a simplified illustration of three primary components of the SAA model, each designed to efficiently process and integrate multimodal data for real-time auditory attention prioritization, in accordance with an embodiment of the present invention;

FIG. 9 is a system spatial interaction scenario showing positional and attention relationships between participants, in accordance with an embodiment of the present invention;

FIG. 10 is a hierarchical block diagram illustrating the hardware integration architecture of the SAA system across multiple processing layers, in accordance with an embodiment of the present invention, in accordance with an embodiment of the present invention; and

FIG. 11 is an architecture diagram of the SAA neural processing pipeline, in accordance with an embodiment of the present invention;

FIG. 12, is a simplified diagram of a memory management system with memory allocation and tensor pooling, in accordance with an embodiment of the present invention; and

FIG. 13 is a simplified diagram of buffer management for synchronization and feature processing, in accordance with an embodiment of the present invention.

For reference to the figures, the following index of elements and their numerals is provided. Similarly numbered elements represent elements of the same type, but they need not be identical elements.

TABLE of elements in the figures

| Element | Description |
|---|---|
| 10 | conversation participants - |
| | speakers and listeners |
| 20 | AI assistant |
| 30 | smart goggles |
| 40 | laptop computers |
| 110 | sensors |
| 120 | microphone array |
| 130 | speaker |
| 200 | multimodal AI processor |
| 210 | signal preprocessors |
| 220 | audio signal preprocessor |
| 230 | synchronizer |
| 240 | feature extractor |
| 250 | machine learning models that |
| | interact with each other |
| | in arbitrary ways |
| 260 | conversation graph generator |
| 270 | adaptive audio gain controller |
| 310 | feature vector construction |
| 311 | spatial stream |
| 312 | rotation stream |
| 313 | audio processing |
| 314 | gaze tracking |
| 320 | temporal alignment |
| 321 | window system |
| 322 | sync mechanism |
| 323 | buffer control |
| 330 | multimodal attention |
| 331 | attention heads |
| 332 | cross-modal |
| 333 | fusion control |
| 340 | output |
| 341 | state predictor |
| 342 | graph |
| 410 | input processing |
| 411 | spatial |
| 412 | audio |
| 413 | gaze |
| 414 | EEG |
| 415 | rotation |
| 420 | fusion engine |
| 421 | temporal align |
| 425 | attention mechanism |
| 426 | spatial attention 4 heads |
| 427 | rotation attention 4 heads |
| 428 | cross-modal fusion mechanism |
| 430 | output processing |
| 431 | probability matrix |
| 432 | conversation graph |
| 510 | primary user device |
| 520 | field of view (120°) |
| 530 | active speaker |
| 540 | listener |
| 550 | secondary speaker |
| 560 | primary attention zone |
| 570 | gaze tracking path |
| 580 | social distance markers |
| 590 | conversation link |
| 610 | hardware layer |
| 611 | depth cameras |
| 612 | eye tracking |
| 613 | spatial audio |
| 614 | motion tracking |
| 615 | processing unit |
| 620 | sensor interface layer |
| 621 | depth interface |
| 622 | gaze interface |
| 623 | audio interface |
| 624 | IMU interface |
| 630 | processing layer |
| 631 | temporal alignment |
| 632 | feature extraction |
| 633 | multimodal fusion |
| 634 | attention modeling |
| 640 | application layer |
| 641 | conversation grouping |
| 642 | Attention prioritization |
| 643 | Real-time visualization |
| 700 | memory management system |
| 710 | tensor memory pool |
| 711 | active buffer #1 |
| 712 | active buffer #2 |
| 713 | active buffer #3 |
| 720 | cache system |
| 721 | L1 cache |
| 722 | L2 cache |
| 730 | memory manager |
| 731 | allocator |
| 732 | garbage collector |
| 740 | resource monitor |
| 810 | buffer manager |
| 811 | sliding window |
| 812 | frame alignment |
| 820 | synchronizer |
| 821 | temporal aligner |
| 822 | interpolator |
| 830 | feature processor |
| 831 | feature extractor |
| 832 | normalizer |

### DETAILED DESCRIPTION

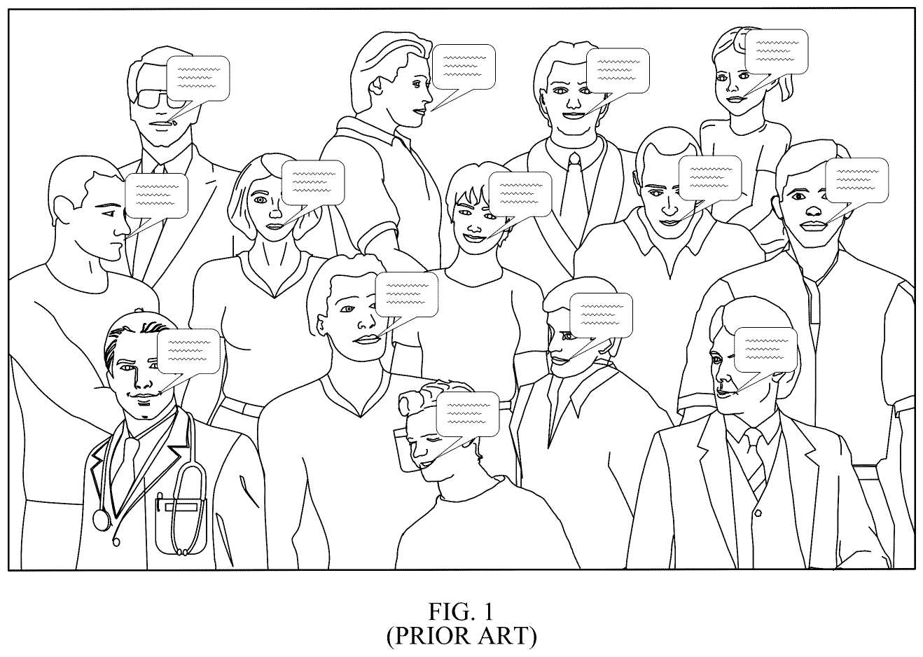

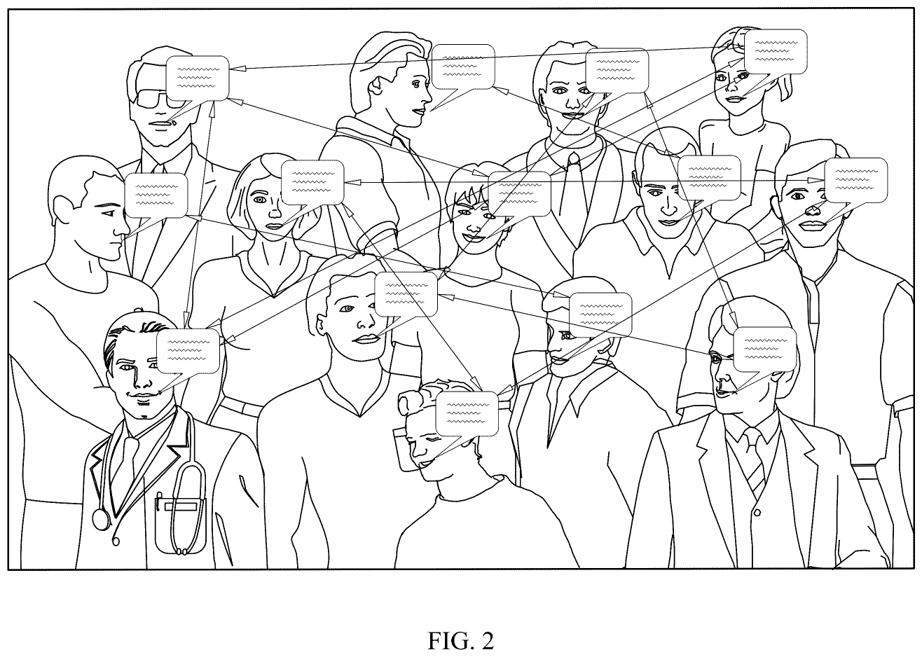

Reference is made to FIG. 2, which is a simplified diagram of attention patterns within the cocktail party shown in FIG. 1, in accordance with an embodiment of the present invention. Each participant is wearing a hearing device. For example, in one important embodiment, each participant is wearing smart glasses with hearing devices. In other embodiments, the participant may be wearing a smart helmet or smart goggles, or separate audio and video devices, such as headphones and glasses. The attention patterns are represented by arrows connecting participants participating in one of the many simultaneous ongoing conversations. The arrows form a “conversation graph” for which nodes represent participants and edges connect participants who belong to the same conversation group.

In practice, it may not be possible to determine with absolute certainty which participants belong to which conversation groups. As such, the conversation graph is expanded to include edges between participants who likely belong to the same conversation group. Each edge is weighted with a probability that the two participants jointed by the edge currently belong to the same conversation group. As such, the conversation graph may be considered to be a complete graph, with edges connecting each pair of participants, the edges being weighted with zero or positive weights.

Embodiments of the present invention analyze the participants using multimodal sensors including inter alia audio, visual and positional sensors, and using natural language processing (NLP), derive the conversation graph, and process the audio to amplify the conversation(s) that each participant is likely paying attention to and suppress conversation(s) that the participant is not paying attention to. Multimodal analysis uses cues such as inter alia the direction at which a participant is gazing, which of the other participants are gazing at him, body movements of the participant and of the other participants, and eye movements of the participant and of other participants. NLP analysis uses semantics to determine the conversation topic of current interest to the participant. Amplification and suppression of conversations is performed by applying large gain levels to audio from a group conversation that a participant is currently paying attention to with high probability, and low gain levels to audio from group conversations that the participant is currently paying attention to with low probability.

In one embodiment of the present invention, the multimodal signal processing that derives the conversation graph is performed within the smart glasses themselves. In another embodiment of the present invention, the multimodal signal processing is performed by a central computing device, local or remote.

It is noted that the above analysis is dynamic. Conversation graphs are dynamic. A participant may transition from one conversation to another. New participants may arrive. Existing participants may leave.

Moreover, one or more participants may be non-human AI agents.

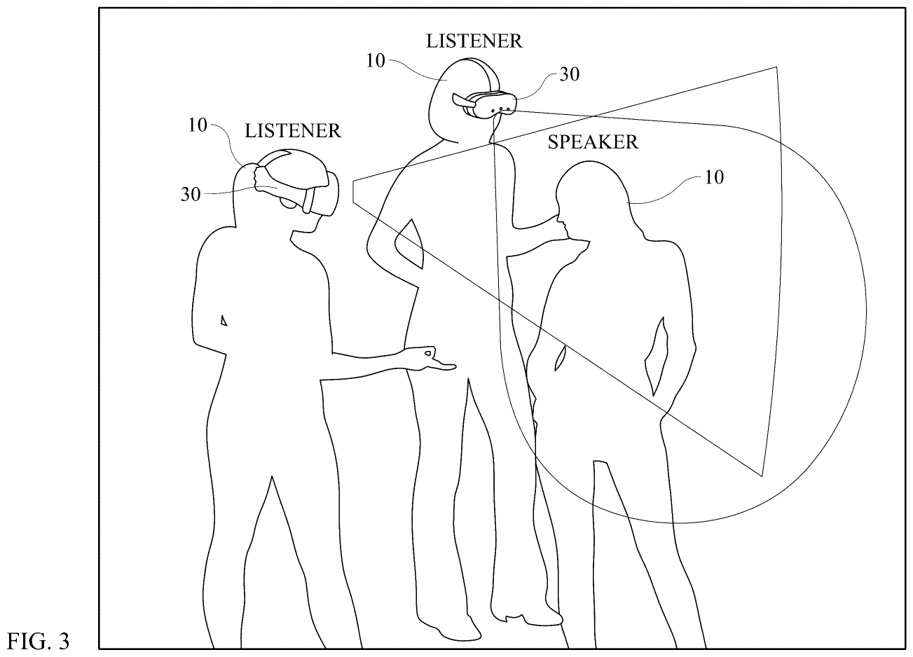

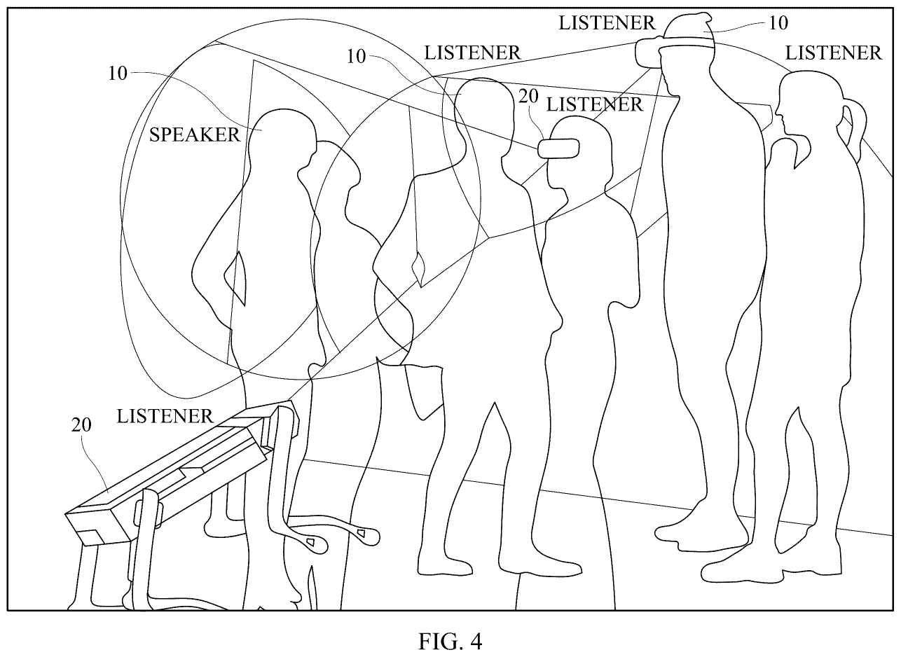

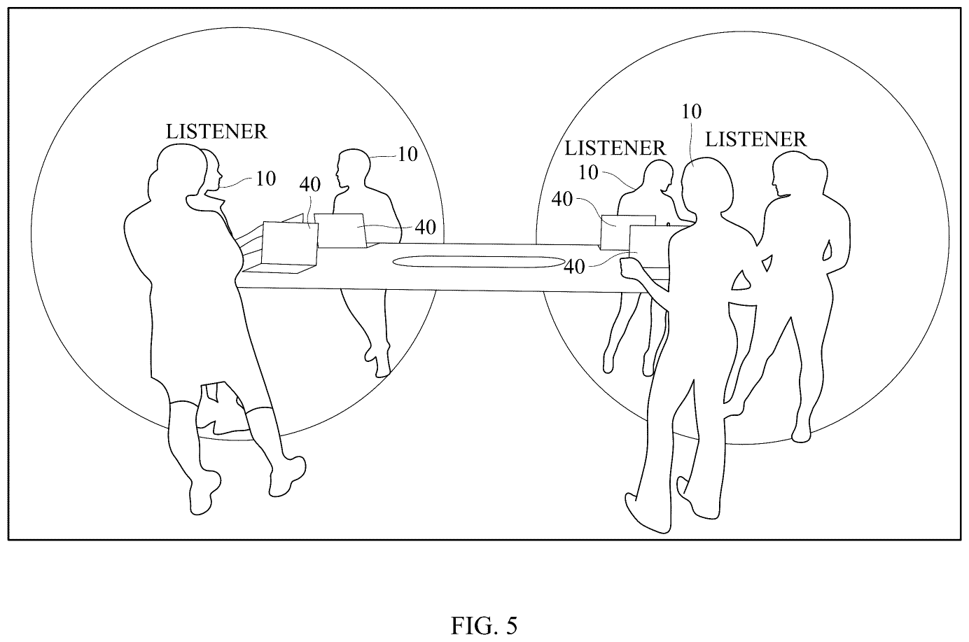

Reference is made to FIGS. 3-5, which are simplified illustrations of various conversations to which SAA (Selective Auditory Attention) may be applied, in accordance with embodiments of the present invention. FIGS. 3-5 show participants 10 and an AI assistant 20, some of which are speakers and others of which are listeners, engaged in group conversations. Some participants are wearing smart goggles 30 and some participants are using laptop computers 40. Smart goggles 30 and laptop computers 40 include software enabling each listener to focus on a respective speaker.

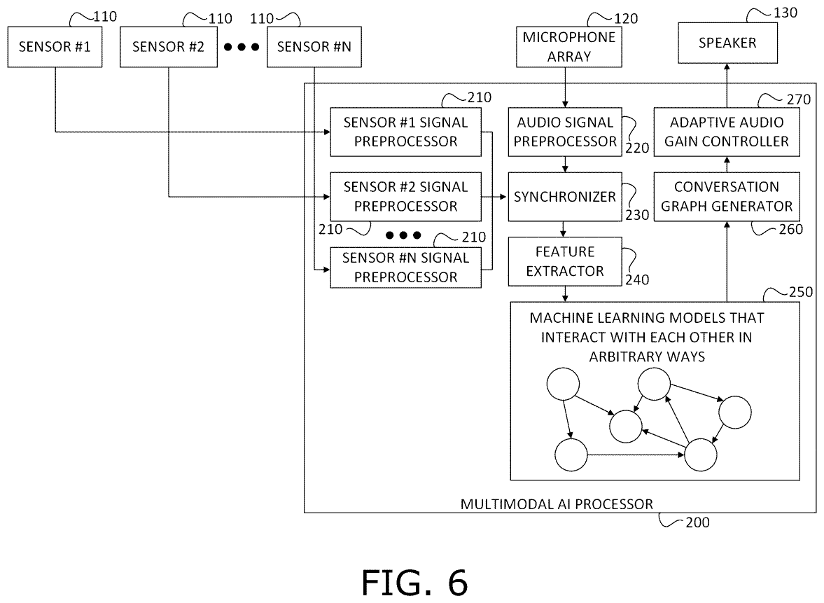

Reference is made to FIG. 6, which is a simplified block diagram of apparatus for selective auditory attention in multi-participant environments, in accordance with an embodiment of the present invention. The apparatus of FIG. 6 includes a plurality 110 of N sensors and a microphone array 120. The apparatus of FIG. 6 also includes a speaker 160. The apparatus of FIG. 6 also includes a multimodal artificial intelligence (AI) processor 200 with seven components; namely, N respective signal preprocessors 210 for the signals output from sensors 110, an audio signal preprocessor 220, a synchronizer 230, a feature extractor 240, machine learning models 250 that interact with each other in arbitrary ways, a conversation graph generator 260, and a selective auditory controller 270. Sensors 110 may include inter alia multimodal vision sensors, an inertial measurement unit, a gaze tracker and EEG/ECG sensors.

Synchronizer 230 processes output signals from signal pre-processor 210 and from audio signal preprocessor 220. Feature extractor 240 extracts features from signals output from synchronizer 230. Machine learning models 250 process output from feature extractor 240 and derive attention relationships therefrom.

### Signal Preprocessors 210

For video signals, spatial data is input as global coordinates (posX, posY, posZ) from each of one or more VR cameras. Spatial data is normalized to a common coordinate system (range: [−1, 1]). Spatial data is calibrated to align multiple devices, by defining ORIGIN_POINT=(0, 0, 0), performing initial calibration by comparing XYZ values across devices, and implementing continuous calibration for yaw, pitch and roll values. Coordinate systems are transformed using a transformation matrix. Feature extraction is applied by feature extractor 250 to spatial data, by calculating Euclidean distances between all participant pairs, and calculating velocity and acceleration calculations using finite differences.

Gaze tracking data is input as a video buffer from cameras and infrared LEDs. Pupil detection is applied using blob detection and ellipse fitting. Corneal reflection is detected for each IR LED. Feature extraction is applied by feature extractor 250 to gaze tracking data using pupil center and corneal reflection vector calculation. Gaze direction is estimated using polynomial regression mappings. Saccade detection is applied using velocity threshold algorithms. Fixation is identified and duration is calculated. Blinks are detected and blink rates are estimated. Attention focus is determined by ray casting from estimated gaze direction, intersection detection with other participants or objects, and calculation of attention dwell time on targets.

Inter-participant dynamics are derived by computing pairwise distances between all participants, computing relative velocity and acceleration between participant pairs, and detecting group formation detection using hierarchical clustering. Social network analysis metrics, including centrality and clustering coefficient using a central point calculation. A weighted average is calculated by computing the weighted average of participant positions:

$$central\_point = \sum ( w\_i * phi ) / \sum w\_i \qquad ( 1 )$$

where w_i is the weight for participant i, and p_i is their position. Weights are determined by factors such as (i) speaking time—more weight for active speakers, and (ii) gaze direction—higher weight when looking towards other participants. A Kalman filter is implemented for smooth tracking, using (i) a state vector:

$$x = [ position , velocity , acceleration ] \qquad ( 2 )$$

a measurement vector:

$$z = [ measured\_position ] \qquad ( 3 )$$

a state transition model:

$$x\_k = F * x\_k - 1 + w\_k \qquad ( 4 )$$

where F is the state transition matrix and w_k is process noise, and a measurement model:

$$z\_k = H * x\_k + v\_k \qquad ( 5 )$$

where H is a measurement matrix and v_k is measurement noise. The Kalman filter prediction and update operations are prediction:

$$x\_k \vert k - 1 = F * x\_k - 1 \vert k - 1 \qquad ( 6 )$$

update:

$$x\_k \vert k = x\_k \vert k - 1 + K\_k * ( z\_k - H * x\_k \vert k - 1 ) \qquad ( 7 )$$

where K_k is the Kalman gain. An adaptive prediction model is applied that adjusts prediction parameters based on observed movement patterns using an exponential moving average (EMA) to track recent movement trends, adjusting the process noise covariance Q based on the observed variability in movement, and implementing a multi-model approach, switching between different motion models, e.g., constant velocity, constant acceleration, based on recent behavior.

Dynamic participant grouping is applied by using DBSCAN clustering to identify sub-groups of participants. Eps is set to maximum distance between points based on the current conversation dynamics, and the min_samples parameter is adjusted to define the minimum group size. Edge cases are handled for single participants by using their position as the central point. If there are no active participants, a none or a default position is returned. If participants are spread too far, multiple central points for sub-groups are considered. Outliers are detected and handled using a Z-score based outlier detection:

$$z\_scores = ( X - μ ) / σ \qquad ( 8 )$$

where X is the position data, μ is the mean, and σ is the standard deviation. Positions with z_scores>3 are filtered out to remove potential outliers. The dynamic grouping ensures that a minimum number of valid participants remain after outlier removal.

Real-time performance is optimized using asynchronous processing for time-consuming operations, using GPU acceleration for matrix operations when available, and employing adaptive computation techniques. Update frequency is adjusted based on movement speed and conversation dynamics. Early-exit mechanisms are used for simpler scenarios. An overall processing time of 40 ms per frame or less is targeted to maintain real-time performance.

Validating and error handling is implemented with an is_position_valid function to ensure calculated positions are within tracking bounds. Edge cases such as no active participants or insufficient valid positions are handled. Fallback mechanisms are provided for scenarios where central point calculation fails.

Central area relevance is derived by device filtering and preprocessing. Filter active devices:

$$[ device for device in devices if is\_ device\_active ( device , idle\_threshold = 5. ) ] \qquad ( 9 )$$

Valid positions and looking directions are extracted. Positions are normalized to the range [−1, 1]. Outliers are detected and removed using Z-scores based outlier detection:

$$z\_scores = ( X - μ ) / σ \qquad ( 10 )$$

where X is the position data, μ is the mean, and σ is the standard deviation. Positions with z_scores>3 are filtered out. The central area is derived so as to ensure that a minimum number of valid participants remain after outlier removal.

Contextual relevance is scored by calculating pairwise cosine similarities between looking directions and vectors to other participants. Semantic similarity between participants' utterances is computed using TF-IDF vectors. Relevance scores are adjusted based on semantic features:

$$relevance\_score *= ( 1 + α * semantic\_similarity + β * sentiment\_score + γ * dialogue\_act \_weight ) \qquad ( 11 )$$

where α, β, and γ are tunable parameters.

A weighted central position is calculated by computing

$$central\_position = \sum ( w\_i * p\_i ) / \sum w\_i \qquad ( 12 )$$

where w_i is the relevance score for participant i, and p_i is their position.

Dynamic participant grouping is performed using DBSCAN clustering to identify sub-groups:

$$dbscan = DBSCAN ( eps = max\_distance , min\_samples = 2 ) \qquad ( 13 )$$

$$clustering = dbscan . fit ( positions\_array ) \qquad ( 14 )$$

Edge cases are handled for single participants using their position as the central point. If there are no active participants a None or a default is returned. If participants spread too far, multiple central points for sub-groups are considered.

Kalman filtering is applied for smooth tracking, with state vector:

$$x = [ position , velocity , acceleration ] \qquad ( 15 )$$

and measurement vector:

$$z = [ measured\_position ] \qquad ( 16 )$$

Prediction and updating are implemented,
prediction:

$$x\_k \vert k - 1 = F * x\_k - 1 \vert k - 1 \qquad ( 17 )$$

update:

$$x\_k \vert k = x\_k \vert k - 1 + K\_k * ( z\_k - H * x\_k \vert k - 1 ) \qquad ( 18 )$$

where K_k is the Kalman gain.

An adaptive precision model is used with an exponential moving average (EMA) to track recent movement trends. Process noise covariance Q is adjusted based on observed variability. A multi-model approach (constant velocity, constant acceleration) is implemented, with switching between models based on recent behavior.

Optimization is performed by asynchronous processing. Separate threads are implemented for semantic processing and central area calculation. A producer-consumer pattern with a thread-safe queue for inter-thread communication is used. GPU acceleration is performed by using GPU for matrix operations in DBSCAN (distance between nearest points) clustering and Kalman filtering. NVIDIA® Custom Compute Unified Device Architecture (CUDA) kernels are implemented for cosine similarity calculations.

Adaptive computation is performed by adjusting update frequency based on conversation dynamics:

$$update\_interval = base\_interval * ( 1 + δ * conversation\_complexity ) \qquad ( 19 )$$

Early-exit mechanisms are implemented for simple scenarios. Caching and memorization are performed by caching TF-IDF vectors and topic distributions for recent utterances. Cosine similarity calculations are memorized for frequent participant pairs. Quantization is performed by applying int8 quantization to NLP models-sentiment analysis, dialogue act classification. Mixed-precision operations are used—float16 for intermediate calculations, float32 for accumulations. Real-time performance metrics are obtained by tracking and logging processing times for each component. Rolling average and percentile calculations are implemented for latency monitoring. An alerting system is set up for performance degradation:

$$if avg\_latency > 40 ms : trigger\_performance \_alert ( ) \qquad ( 20 )$$

Validation and error handling are performed by implementing comprehensive input validation for all function parameters. Fallback mechanisms are provided for scenarios where central point calculation fails. Detailed error information is logged for post-hoc analysis and debugging.

### Audio Signal Preprocessor 220

Audio signal pre-processor 220 is responsible for preprocessing raw sensor audio data.

Audio data is input as raw audio streams from microphones, e.g., by a 48 KHz sampling rate. Audio data pre-processing is done by a short-time Fourier transform (STFT) for time-frequency representation, and by spectral subtraction for ambient noise reduction. Feature extraction is applied by feature extractor 240 to audio data. Voice activity detection (VAD) is applied using energy-based detection with adaptive thresholding, machine learning (ML)-based classification using a lightweight convolutional neural network (CNN), preferably with 3 convolutional layers and fully connected (FC) layers. Amplitude is classified using root-mean-square (RMS) over 0.25-second windows, normalized to [0, 1], mel-frequency cepstral coefficients (MFCCs)—13 coefficients, 25 ms window, 10 ms stride, fundamental frequency (F0) estimation using an autocorrelation method, and spectral flux for onset detection and speech segmentation.

Semantic verbal cues are processed and central areas are calculated. Speech from each participant is input using real-time speech recognition and device positions (posX, posY, posZ).

Semantic processing is applied by keyword extraction using a term frequency-inverse document frequency (TF-IDF) algorithm for real-time keyword extraction. A sliding window of recent utterances, e.g., the last 30 seconds, is maintained for each participant. TF-IDF scores are updated incrementally as new speech input is processed. A count-min sketch data structure is used for efficient frequency tracking. Stemming or lemmatization is applied for word normalization.

Topic modeling is applied by implementing online latent Dirichlet allocation (LDA) for dynamic topic modeling. Topic distributions are updated for each participant in real-time. Topic evolution is tracked using exponential decay for older topics.

Sentiment analysis is applied using a lightweight sentiment analysis model, e.g., Valence Aware Dictionary and Sentiment Reasoner (VADER). Sentiment scores, positive, negative and neutral, are computed for each utterance. A rolling average sentiment is calculated for each participant.

Dialogue acts are classified by implementing a pre-trained classifier for identifying dialogue acts, e.g., question, statement and agreement, using a compact model suitable for real-time processing on wearable devices.

### Synchronizer 230

Synchronizer 230 combines processed inputs from various modalities into a unified representation. Temporal alignment is performed by implementing a sliding window approach with adaptive size, 50-200 ms. Cubic spline interpolation is used for smooth transitions in continuous data. Lanczos resampling for audio features is applied to preserve high-frequency information. Custom time warping algorithm is used for handling different sensor rates.

Synchronizer 230 synchronizes all devices to a common Network Time Protocol (NTP) server. Synchronization between devices is achieved with millisecond precision using a hybrid network architecture, leveraging both local and cloud-based services as detailed in Applicant's hybrid multimedia conferencing patent, U.S. Pat. No. 11,824,906 B2. The architecture allows for dynamic synchronization across heterogeneous devices in hybrid environments. Synchronization is maintained by LAN-based clock synchronization, by a heartbeat protocol for continuous sync, by hybrid synchronization, by multimedia playback synchronization, by cross-device synchronization, and by failover for real-time sync.

For LAN-based synchronization, local devices communicate through a local area network (LAN) with a distributed local service, ensuring minimal latency. A high-precision NTP service is implemented within the LAN to maintain accurate, sub-millisecond synchronization between devices. This local NTP service mitigates potential delays or inconsistencies from external internet NTP servers by utilizing low-latency, internal LAN connections.

For a heartbeat protocol, each local device, along with the distributed local service, continuously exchanges a “heartbeat” signal containing timestamped state information, including processing delays, network jitter, and multimedia capture latency. This information allows the system to adjust for any temporal drifts by recalculating clock skew and realigning streams to ensure that audio, video, and other sensory inputs remain in sync to the millisecond.

For hybrid synchronization, a local service synchronizes with the cloud-based remote service at regular intervals via a hybrid sync mechanism that combines clock signals from both LAN-based NTP and internet-based NTP servers. This dual-layered approach ensures that even if one source experiences latency or drift, the system can compensate using the other clock source. For cross-region or remote participants, clock drift between the cloud and local devices is continuously monitored, and sync adjustments are applied in real-time to keep the global conference in sync down to milliseconds.

For multimedia playback synchronization, a playback synchronizer is crucial for maintaining temporal alignment across devices. It adjusts media stream timing on local devices to ensure that all participants experience synchronized playback of audio and video, using algorithms including clock skew correction and dynamic buffering. Synchronizer 230 enables seamless switching between multimedia streams, providing millisecond-level accuracy in transitions.

Cross-device synchronization is crucial due to the spatial and real-time interactive nature of the environment. Synchronizer 230 integrates timestamped data packets from all devices into the hybrid network. Each frame of visual data, haptic feedback, or audio stream is tagged with a timestamp accurate to the millisecond. These data packets are aligned across local and remote participants, enabling smooth experiences without perceptual lag or drift in shared environments.

For a failover, if a device experiences latency or loses connection, synchronizer 230 immediately reassigns the synchronization duties to another optimal local device, as detailed in the resilience protocol presented hereinbelow. This process ensures that synchronization is maintained without interruption, avoiding desync issues across devices.

Synchronizer 230 uses a sophisticated sliding window approach to align data streams, ensuring all modalities are synchronized based on the provided timestamps. The alignment process involves (i) defining a window size, (ii) data collection and interpolation, (iii) resampling to a common frequency, (iv) alignment, and (v) asynchronous updates.

Regarding window size, synchronizer 230 uses a primary window size: 100 ms, and an extended window for context: 500 ms, centered on the primary window.

Regarding data collection and interpolation, for each window, synchronizer 230 collects data points across modalities. Linear interpolation is used for missing data points:

$$y = y 1 + ( x - x 1 ) * ( y 2 - y 1 ) / ( x 2 - x 1 ) \qquad ( 21 )$$

Cubic spline interpolation is used for smoother transitions in rotational data.

Regarding resampling, a target frequency of 100 Hz is used with 10 ms intervals. Lanczos resampling is applied for audio features to preserve high-frequency information.

Regarding alignment, the latest timestamp among all modalities within the window is identified. All other modalities are aligned to this reference timestamp. A causal constraint is applied, using data available at or before the reference time.

Regarding asynchronous updates, a buffer of recent samples for each modality is maintained. The buffer is updated asynchronously as new data arrives. During alignment, the most recent available data for each modality is used.

Synchronizer 230 ensures that data from different sensors with varying sampling rates are properly aligned for processing, while also providing temporal context for the model.

### Feature Extractor 240

Feature extractor 240 performs audio feature extraction using voice activity detection. Feature extractor 240 uses two key audio features; namely, talking and average amplitude.

Regarding talking, a Boolean flag indicates whether the user is currently speaking. Computation uses a two-stage approach; namely, energy-based detection and machine learning (ML)-based classification.

For energy-based detection, feature extractor 240 computes short-time energy:

$$E ( n ) = \sum x \hat{} 2 ( m ) , m = n - N + 1 to n \qquad ( 22 )$$

and applies adaptive thresholding based on background noise estimation.

For ML-based classification, feature extractor 240 uses a lightweight neural network (e.g., 3 conv layers, 2 FC layers) which receives as input MFCC features (e.g., 13 coefficients, 25 ms window, 10 ms stride), and generates probability of speech presence as output.

Regarding average amplitude, a float value represents the average amplitude of a user's speech (e.g., over the last 0.5 seconds). Feature extractor 240 computes RMS amplitude

$$RMS = sqrt ( 1 / N * \sum x \hat{} 2 ( n ) ) , n = 1 to N \qquad ( 23 )$$

where N=8000 for 0.5 seconds at 16 kHz sampling rate, and normalizes by scaling to [0, 1] range based on historical min/max values.

Feature extractor 240 derives inter-participant distances by using a playerDistances array, which provides for each participant a distance and an indicator of the participant it is looking at. The distance is provided as a float value representing the distance to the player in unity units, corresponding to meters, and computes a Euclidean distance between participant positions

$$d = sqrt ( ( x 2 - x 1 ) \hat{} 2 + ( y 2 - y 1 ) \hat{} 2 + ( z 2 - z 1 ) \hat{} 2 ) \qquad ( 24 )$$

and normalizes by scaling to a [0, 1] range based on maximum scene dimensions.

Feature extractor 240 derives an indicator IsLookingAt, which is a Boolean flag indicating whether the user is looking at a participant. Feature extractor 240 derives this indicator by calculating a gaze direction vector from a user's rotation, computing an angle between a gaze vector and a vector to each player, and setting a flag to true if the angle is below threshold, e.g., 15°.

Each data point is associated with a DateTime timestamp to ensure proper temporal alignment of all modalities. The timestamp is formatted according to ISO 8601 (e.g., “2024-10-20T14:55:16.005Z”), with a resolution of millisecond precision.

Feature extractor 240 normalizes data by applying min-max normalization for bounded features, e.g., spatial coordinates. Z-score normalization is used for unbounded features, e.g., distances. Adaptive normalization is implemented with exponential moving average for dynamic range adjustment. Modality-specific normalization techniques are used, e.g., quaternion normalization for rotations.

Feature extractor 240 uses a multimodal attention mechanism. Feature extractor 240 uses a custom transformer architecture for heterogeneous input handling. Feature extractor 240 implements multi-head attention with modality-specific attention heads using spatial attention for position and movement, temporal attention for sequence modeling, and cross-modal attention for inter-modality relationships. Feature extractor 240 uses a hierarchical attention mechanism for handling multiple time scales. Feature extractor 240 implements sparse attention patterns for efficiency with high-dimensional data.

Feature extractor 240 performs feature fusion strategies. Early fusion is used for concatenating raw or minimally processed features. Late fusion is used for combining high-level features or decisions from modality-specific models. Hybrid fusion is used for adaptive combination of early and late fusion based on context.

Feature extractor 240 performs contextual embedding. Context-aware embeddings are generated using participant historical data. Feature extractor 250 implements adaptive feature importance weighting based on the current scenario.

Feature extractor 240 constructs a comprehensive feature vector X for each time step t that includes

$$X ( t ) = [ Sp ( t ) ; Rot ( t ) ; VAD ( t ) ; Amp ( t ) ; Dist ( t ) ; Gaze ( t ) ] \qquad ( 25 )$$

where Sp(t)∈R\hat{ }3 is a normalized spatial position (posX, posY, posZ), Rot(t)∈R\hat{ }4 is a quaternion representation of rotation (w, x, y, z), VAD(t)∈{0,1} is voice activity detection, i.e., a talking flag, Amp(t)∈R is a normalized average amplitude, dist(t)∈R\hat{ }N are normalized distances to N players, and Gaze(t)∈{0,1}\hat{ }N are gaze flags for N players. The resulting feature vector has a dimension of 3+4+1+1+N+N=9+2N, where N is the maximum number of players (e.g., 6).

Feature extractor 240 manages multimodal data fusion using conversation state detection. Feature extractor 240 identifies three primary conversation states; namely, group discussion, paired conversations, and disengaged state.

For a group discussion, i.e., dialogue mode, there is an even distribution of turn-taking, there are mutual gaze patterns among all participants, and there are balanced voice levels.

For paired conversations, i.e., split dialogue mode, there are two parallel two-way conversations, there is clear spatial and auditory separation, and there are distinct turn-taking patterns within pairs.

For a temporary disengaged state in a conversation, there is one participant disengaged from the main conversation looking away or reduced mutual gaze with the group for a determined period of time and minimal vocal contribution.

Feature extractor 240 manages state transitions through temporal build-up of attention patterns, gradual gain adjustments during transitions, and continuous monitoring of mutual gaze duration.

Feature extractor 240 applies appropriate normalization techniques to each feature type to ensure consistent scaling across modalities.

Min-max normalization is used for bounded features, and is applied to spatial positions, raycast distance and average amplitude, using the formula

$$X\_norm = ( X - X\_min ) / ( X\_max - X\_min ) \qquad ( 26 )$$

X_min and X_max are dynamically adjusted based on observed data ranges.

Z-score normalization is used for unbounded features, and is applied to inter-participant distances using the formula

$$X\_norm = ( X - μ ) / σ \qquad ( 27 )$$

where μ and σ are computed using an exponential moving average to adapt to changing conditions. A window size for statistics of 1000 samples is used.

For rotational data, quaternion normalization is used in accordance with

$$q\_norm = q / \vert q \vert \qquad ( 28 )$$

to ensure unit quaternions. Consistency is maintained by ensuring that the w component is always positive.

Logarithmic scaling is used for audio amplitude, applied to average amplitude before min-max normalization in accordance with the formula

$$A\_log = log ( 1 + A ) / log ( 1 + A\_max ) \qquad ( 29 )$$

which is of advantage in handling a wide dynamic range of audio signals.

For binary features, VAD and gaze flags are left as-is, 0 or 1.

Normalization is adaptive. Normalization parameters are updated periodically, e.g., every 5 minutes. A mixture of global and local statistics is used to handle different scenarios. Smooth transitions are implemented when updating normalization parameters to avoid sudden changes.

These normalization techniques ensure that all features contribute equally to the SAA model's decision-making process, regardless of their original scales. The adaptive nature of the normalization allows the system to handle varying environmental conditions and user behaviors.

Feature extractor 240 includes dedicated feature processing subsystems for each input modality, optimized for the specific data characteristics and computational requirements.

Spatial processing operates at 90 Hz and employs a Kalman filter to smooth the 3D position estimates of the conversation participants. The filter maintains a state vector containing position, velocity, and acceleration estimates, and updates its predictions based on the incoming measurements. Spatial processing also performs coordinate transformations to align the spatial data across devices and applies outlier rejection techniques to handle noisy inputs.

Spatial processing employs a Kalman filter with the following state transition and observation models.

$$State vector = [ x , y , z , vx , vy , vz , ax , ay , az ] \qquad ( 30 )$$

$$transition matrix = [ \begin{matrix}1 & 0 & 0 & dt & 0 & 0 & 0.5 dt \hat{} 2 & 0 & 0\end{matrix} ] [ \begin{matrix}0 & 1 & 0 & 0 & dt & 0 & 0 & 0.5 dt \hat{} 2 & 0\end{matrix} ] [ \begin{matrix}0 & 0 & 1 & 0 & 0 & dt & 0 & 0 & 0.5 dt \hat{} 2\end{matrix} ] [ \begin{matrix}0 & 0 & 0 & 1 & 0 & 0 & dt & 0 & 0\end{matrix} ] [ \begin{matrix}0 & 0 & 0 & 0 & 1 & 0 & 0 & dt & 0\end{matrix} ] [ \begin{matrix}0 & 0 & 0 & 0 & 0 & 1 & 0 & 0 & dt\end{matrix} ] [ \begin{matrix}0 & 0 & 0 & 0 & 0 & 0 & 1 & 0 & 0\end{matrix} ] [ \begin{matrix}0 & 0 & 0 & 0 & 0 & 0 & 0 & 1 & 0\end{matrix} ] [ \begin{matrix}0 & 0 & 0 & 0 & 0 & 0 & 0 & 0 & 1\end{matrix} ] \qquad ( 31 )$$

$$and$$

$$observation matrix = [ \begin{matrix}1 & 0 & 0 & 0 & 0 & 0 & 0 & 0 & 0\end{matrix} ] [ \begin{matrix}0 & 1 & 0 & 0 & 0 & 0 & 0 & 0 & 0\end{matrix} ] [ \begin{matrix}0 & 0 & 1 & 0 & 0 & 0 & 0 & 0 & 0\end{matrix} ] \qquad ( 32 )$$

Audio processing operates at 48 kHz and uses a combination of MFCC features and x-vector embeddings to capture both low-level spectral characteristics and higher-level speaker information. The MFCC pipeline applies a series of signal processing operations, including windowing, FFT computation, mel-scale filter bank application, and DCT computation, to extract a compact feature representation. The x-vector embedding network is a pre-trained deep neural network that generates fixed-length speaker embeddings from variable-length audio segments.

Audio processing extracts relevant acoustic features including spectral characteristics, pitch information and energy metrics. The system employs neural network architectures to generate compact speaker representations suitable for real-time processing and attention modeling.

Gaze processing operates at 120 Hz and fuses information from multiple sensors, including eye-tracking cameras and EEG measurements. A ray-casting algorithm is used to map the 2D gaze positions to 3D points in the environment, while a saliency model predicts the most informative regions. Gaze processing tracks gaze fixations and saccades to identify the most relevant conversation participants.

Gaze processing uses the following ray-casting algorithm. Origin: 3D position of the eye center, direction: 3D gaze vector in world coordinates, intersection test: ray-sphere intersection with participant head models-sphere center 3D head position and sphere radius 0.15 m, which is an average human head radius.

### Machine Learning Models 250

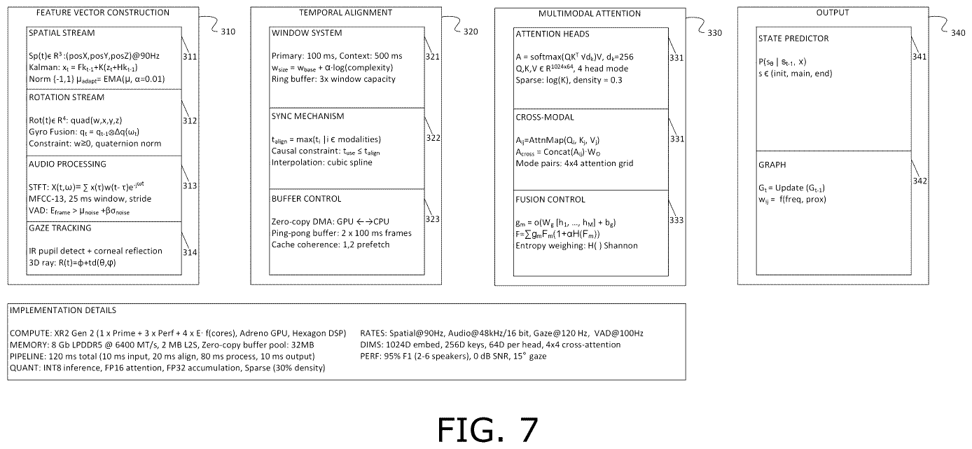

Reference is made to FIG. 7, which is an architecture diagram of the SAA neural processing pipeline, in accordance with an embodiment of the present invention. The processing pipeline includes four primary stages: (i) feature vector construction 310 processes multimodal inputs through specialized streams including (i) spatial 311 with Kalman filtering and adaptive normalization, (ii) rotational 312 with quaternion representations and gyro fusion, (iii) audio 313 implementing STFT and MFCC processing, and (iv) gaze 314 with IR pupil detection; temporal alignment 320 manages synchronization through window system 321, sync mechanism 322, and buffer control 323; multimodal attention 330 implements the attention mechanism through attention heads 331, cross-modal integration 332, and fusion control 333; and output 340 generates state predictions 341 and graph updates 342. Implementation specifications detail hardware utilization including memory configuration, processing pipeline timings, and quantization parameters.

Feature vector construction 310 uses spatial stream processing 311, and processes 3D coordinates (posX, posY, posZ) at 90 Hz. SAA implements Kalman filtering:

$$x\_t = Fk\_ ( t - 1 ) + Kt \cdot z\_t + Hk\_ ( t - 1 ) \qquad ( 33 )$$

and applies adaptive normalization in [−1, 1] range with μ=0.01. Feature vector construction 310 maintains spatial coherence through filtering and normalization.

Rotation stream processing 312 handles quaternion rotations (w,x,y,z) with unit normalization, and integrates gyroscope fusion:

$$q\_t = q\_ ( t - 1 ) ⊗ Δ q ( ω\_t ) \qquad ( 34 )$$

Rotation stream processing 312 enforces quaternion constraints:

$$‖ w ‖ = 1 \qquad ( 35 )$$

and provides smooth rotational updates.

Audio processing 313 implements STFT with

$$Σ x ( t ) w ( t - n ) e \hat{} ( - j ω t ) \qquad ( 36 )$$

transform, and applies MFCC extraction with 25 ms windows and 10 ms stride. Audio processing 313 performs VAD based on

$$E\_frame > μ\_noise + β * σ\_noise \qquad ( 37 )$$

and enables real-time audio feature extraction.

Gaze tracking 314 uses IR pupil detection and corneal reflection. Gaze tracking 314 implements 3D ray casting:

$$R ( t ) = o + td ( θ , φ ) \qquad ( 38 )$$

at 120 Hz, and provides accurate gaze direction estimation.

Temporal alignment 320 uses window system 321, with a primary processing window of 100 ms, a context window of 500 ms, adaptive sizing

$$w\_size = w\_base + α * log ( complexity ) \qquad ( 39 )$$

and a ring buffer maintaining 3× window capacity.

Synchronization mechanism 322, ensures causal alignment across modalities, uses cubic spline interpolation, and maintains temporal consistency.

Buffer control 323 implements zero-copy DMA between GPU and CPU, manages a ping-pong buffer for 2×100 ms frames, and utilizes L2 prefetch for cache coherence.

Multimodal attention 330 includes attention heads 331, cross-modal integration 332 and fusion control 334.

Attention heads 331 implements softmax (QK\hat{ }T/√d_k)V attention mechanism, utilizes 1024×64 embedding dimensions, applies sparse TopK with density=0.3, and uses 4×4 cross-attention grid structure.

Cross-modal integration 332 computes

$$A\_ij = AttnMap ( Q\_i , K\_j , V\_j ) \qquad ( 40 )$$

concatenates attention outputs:

$$A\_cross = Concat [ A\_ij ] * W\_O \qquad ( 41 )$$

and maintains mode pairs across the attention grid.

Fusion control 333 calculates

$$g\_m = σ ( W\_gh \_ 1 : … h\_M + b\_g ) \qquad ( 42 )$$

applies entropy-weighted fusion:

$$F = Σg\_mF \_m ( 1 + α H ( F\_m ) ) \qquad ( 43 )$$

and uses Shannon entropy for weighting.

Output generation 340 includes state prediction 341 and graph updates 342.

State prediction 341 generates P(s_θn_(t+1)|s), manages state transitions, and handles initiation/maintenance/end states.

Graph updates 342 updates conversation graph

$$G\_ \{ t \} = UpdateG ( G\_ \{ t - 1 \} ) \qquad ( 44 )$$

computes edge weights:

$$w\_ij = f ( freq , prox ) \qquad ( 45 )$$

and maintains temporal consistency.

The SAA model's neural network architecture is designed for efficient real-time processing of multimodal inputs on resource-constrained wearable devices. The following description details the low-level implementation of the core processing pipeline, feature extraction systems, memory management, hardware-specific optimizations and runtime performance engineering techniques employed to achieve the model's design objectives. There is a low-level implementation architecture and a core processing pipeline implementation.

The SAA model's processing pipeline is carefully engineered to meet the strict latency requirements for real-time operation. The pipeline is divided into three main stages: input (10 ms), processing (80 ms) and output (10 ms).

The input stage handles ingestion of raw sensor data from multiple streams, including spatial, rotational, audio and gaze inputs. A priority-based queuing system is used to synchronize the streams and to ensure timely processing of critical data. The input stage also performs initial error detection and validation checks to maintain data integrity.

The processing stage contains the bulk of the computational workload, including feature extraction, model inference and state tracking. Modality-specific feature extraction pipelines process the input data in parallel, producing compact representations for the attention mechanisms. A main inference path runs the extracted features through a deep transformer network, which is optimized for the target hardware. Adaptive computation routing dynamically directs the data flow based on the input complexity and available resources. The processing stage also updates the conversation state based on the model's predictions.

The output stage generates the final predictions, updates the conversation graph and formats the results for visualization. It performs additional validation checks to ensure consistency and reliability of the model's outputs.

The system ingests multiple data streams including spatial coordinates, rotational data as quaternions, multi-channel audio data, and gaze coordinates. Each data stream is sampled at rates appropriate for its modality, with higher-frequency sampling for motion-sensitive data and lower-frequency sampling for more stable measurements.

The output stage generates predictions at a rate of 60 Hz, with a target latency of 10 ms for data formatting and transmission.

### Liquid Neural Network (LNN)

The SAA model may be implemented using a custom LNN-based architecture, which leverages the unique temporal modeling capabilities and adaptive nature of LNNs to address the challenges of real-time auditory attention modeling in smart glasses.

The core of the LNN-based SAA model consists of key components; namely, adaptive recurrent units.

The foundation of the LNN architecture is the adaptive recurrent unit, which allows for dynamic temporal processing of input sequences. These units incorporate adaptive time constants. The time constants of recurrent connections are not fixed, but rather are modulated by the current input and hidden state. This is achieved through the use of learnable scaling factors that multiply the time constants, allowing the network to adapt its temporal processing to the characteristics of the input data.

The time constant of the recurrent connection from the i-th neuron to the j-th neuron is given by:

$$τ\_ij = τ\_base ⋆ exp ( w\_ij * h\_i + b\_ij ) \qquad ( 46 )$$

where τ_base is a base time constant, w_ij and b_ij are learnable parameters that depend on the current hidden state h_i.

To control the flow of information within the recurrent connections, the adaptive recurrent units employ gating mechanisms inspired by long short-term memory (LSTM) and gated recurrent unit (GRU) architectures. These gates dynamically regulate the degree of information that is remembered, forgotten, and propagated through time.

The gating equations for the j-th neuron are

update gate:

$$z\_j = σ ( W\_z x\_j + U\_z h\_ \{ j - 1 \} + b\_z ) \qquad ( 47 )$$

reset gate:

$$r\_j = σ ( W\_r x\_j + U\_r h\_ \{ j - 1 \} + b\_r ) \qquad ( 48 )$$

new state:

$$h\_j = ( 1 - z\_j ) * h\_ \{ j - 1 \} + z\_j * tanh ( W\_h x\_j + U\_h ( r\_j * h\_ \{ j - 1 \} ) + b\_h ) \qquad ( 49 )$$

where σ is the sigmoid activation function, and W, U and b are the learnable parameters.

To introduce temporal dynamics and nonlinearity into the recurrent connections, the adaptive recurrent units employ nonlinear activation functions such as leaky ReLU or smooth approximations of the step function.

The recurrent update equation for the j-th neuron is:

$$h\_j = f ( W\_h x\_j + U\_h h\_ \{ j - 1 \} + b\_h ) \qquad ( 50 )$$

where f is the nonlinear activation function.

The LNN-based SAA model incorporates a reservoir computing module, which consists of a large, sparsely connected pool of recurrent units. This reservoir acts as a temporal feature extractor, preserving the dynamic patterns present in the input data.

The reservoir is initialized with random, fixed weights and is not trained directly. Instead, the reservoir states are used as inputs to a trainable readout mechanism that maps the temporal representations to the desired output (i.e., the conversation probability matrix).

The reservoir update equation is:

$$h\_r = f ( W\_r x + U\_r h\_r + b\_r ) \qquad ( 51 )$$

where h_r are the reservoir states, W_r and U_r are the randomly initialized input-to-reservoir and recurrent reservoir weights, and b_r are the biases.

The readout layer of the LNN-based SAA model is responsible for mapping the reservoir representations to the desired output. This can be implemented using techniques such as ridge regression or trainable output weights.

The readout equation is:

$$y = W\_out h\_r + b\_out \qquad ( 52 )$$

where y is the output (the conversation probability matrix), and W_out and b_out are the learnable readout weights and biases.

To integrate the heterogeneous input modalities (spatial, rotational, audio, etc.) in the LNN-based SAA model, the architecture employs multimodal fusion; i.e., modality-specific recurrent layers that are then combined through an adaptive fusion mechanism.

One approach is to use modality-specific gating, where each modality has its own set of update, reset, and new state gates that control the flow of information from that modality into the shared representation:

$$z\_m = σ ( W\_z \hat{} m x \hat{} m + U\_z \hat{} m h + b\_z \hat{} m ) \qquad ( 53 )$$

$$r\_m = σ ( W\_r \hat{} m x \hat{} m + U\_r \hat{} m h + b\_r \hat{} m ) \qquad ( 54 )$$

$$and$$

$$h\_m = ( 1 - z\_m ) * h + z\_m * tanh ( W\_h \hat{} m x \hat{} m + U\_h \hat{} m ( r\_m * h ) + b\_h \hat{} m ) \qquad ( 55 )$$

The fused representation is then obtained by concatenating or summation of the modality-specific hidden states:

$$h = [ h\_ 1 ; h\_ 2 ; … ; h\_M ] \qquad ( 56 )$$

Alternatively, a hierarchical attention mechanism may be used, where the model learns to dynamically weight the contributions of each modality based on the current context.

The LNN-based SAA model is trained using the following strategies.

Similar to the Transformer-based approach, the LNN model employs the sophisticated sliding window technique for temporal alignment of the multimodal inputs. Modality-specific normalization methods, such as quaternion normalization for rotational data, are also applied.

The loss function for the LNN-based SAA model follows a similar structure to the Transformer-based approach, combining binary cross-entropy, Kullback-Leibler divergence, temporal consistency, and sparsity regularization.

The LNN model is trained using the Adam optimizer with a cosine annealing learning rate schedule. Gradient clipping and mixed precision training are also implemented to improve convergence and reduce memory usage.

To efficiently deploy the LNN-based SAA model on resource constrained hardware such as mixed reality headsets, as an example, several optimization strategies are employed.

The LNN architecture's ability to selectively activate recurrent units based on the current input is leveraged to achieve dynamic resource allocation and power-efficient processing. Only the necessary computational units are engaged, reducing the overall computational load.

Specialized CUDA kernels are developed for common LNN operations, such as the adaptive recurrent units and reservoir computations. These custom operators are optimized for the hardware, providing significant performance improvements over general-purpose implementations.

Techniques like in-place updates, tensor pooling, and custom memory allocators are employed to minimize the memory footprint of the LNN-based SAA model. This is crucial for operating within the limited memory resources of the hardware.

Similar to the transformer-based approach, the LNN model benefits from quantization-aware training and other compression techniques to reduce the model size and improve inference speed on the device.

The overall LNN-based SAA model architecture consists of the following components.

Input embedding layer: this layer maps the heterogeneous inputs (spatial, rotational, audio, etc.) to a common embedding space using modality-specific techniques, such as quaternion embeddings for rotational data.

Temporal processing module: the core of the LNN-based model is the temporal processing module, which includes the adaptive recurrent units, reservoir computing, and multimodal fusion mechanisms described earlier.

Attention mechanism: the LNN architecture incorporates custom attention mechanisms that are compatible with the temporal dynamics modeling capabilities of LNNs. This may involve techniques like time-varying attention or hierarchical attention structures, where the model dynamically adjusts the attention weights based on the current context.

Output layer: the output layer of the LNN-based SAA model projects the processed representations to the conversation probability matrix, similar to the Transformer-based approach.

By leveraging the unique properties of LNNs, such as their inherent temporal awareness and adaptive nature, the LNN-based SAA model provides advantages in the Transformer-based architecture in key areas.

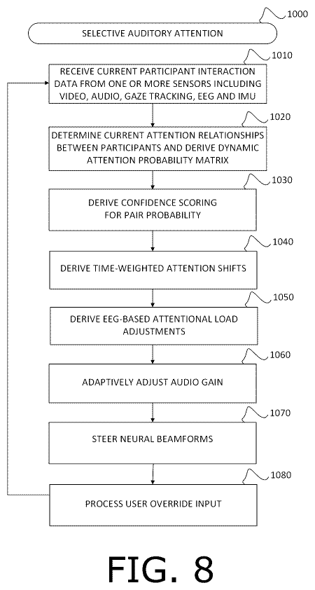

Reference is made to FIG. 8, which is a simplified flowchart of a method 1000 for selective audio attention in multi-participant environments, in accordance with an embodiment of the present invention. At operation 1010 multimodal AI processor 200 receives current participant interaction data form one or more sensors, such as from multimodal vision sensor 110, microphone array 120, IMU 130, EEG/ECG sensors 140, and infrared gaze tracker 150. At operation 1020 attention neural network 270 determines current attention relationships between participants and derives a dynamic attention probability matrix. At operation 1030 attention neural network 270 derives confidence scoring for each pair probability of each pair of participants. At operation 1040 multimodal AI processor 200 derives time-weighted attention shifts. At operation 1050 multimodal AI processor 200 derives EEG-based attentional load adjustments. At operation 1060 adaptive audio gain controller 280 selectively amplifies and attenuates audio based on the current attention probabilities. At operation 1070 multimodal AI processor 200 steers neural beamforms. At operation 1080 multimodal AI processor 200 processes user override input. Flow then returns to operation 1010 to advance to a next timestep.

### SAA Model High-Level Architecture

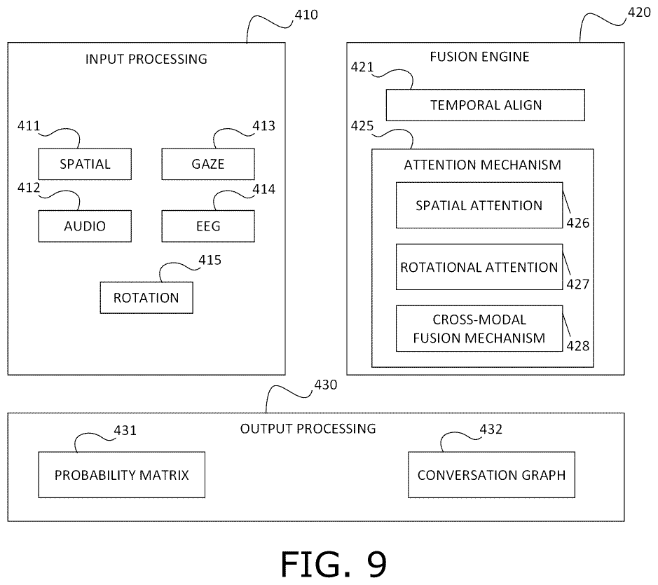

Reference is made to FIG. 9, which is a simplified illustration of three primary components of the SAA model, each designed to efficiently process and integrate multimodal data for real-time auditory attention prioritization, in accordance with an embodiment of the present invention. An input processing component 410 handles raw sensor data from spatial 411, audio 412, gaze 413, EEG 414, and rotation 415 inputs. A multimodal fusion engine 420 incorporates temporal alignment 421 and a multi-head attention mechanism 425 with spatial attention 426, rotation attention 427, and cross-modal fusion 428 components. An output processing component 430 generates a conversation probability matrix 431 and determines a conversation graph 432. The SAA model employs a multi-head attention mechanism, preferable a 4-head attention mechanism, for both spatial and rotational data processing, enabling efficient multimodal fusion for real-time attention modeling in smart glasses applications.

### Output Processing Component 430

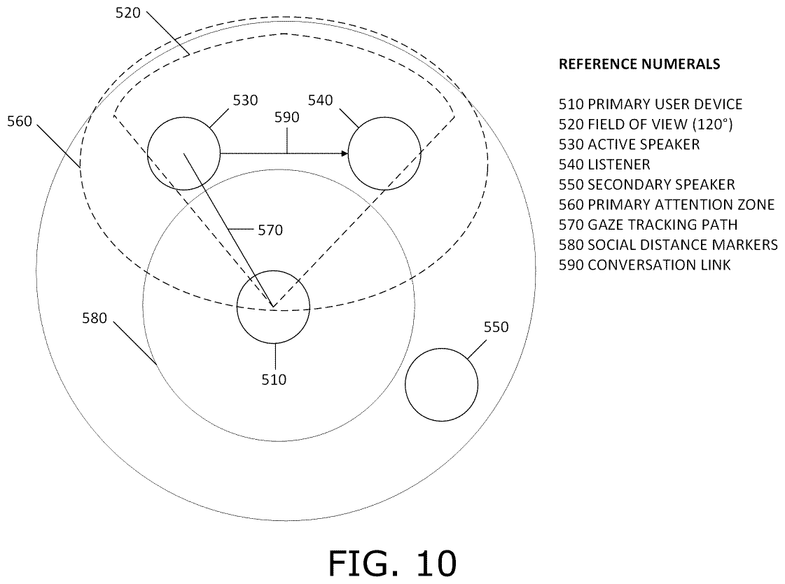

Reference is made to FIG. 10, which is a SAA system spatial interaction scenario showing positional and attention relationships between participants, in accordance with an embodiment of the present invention. A primary user device 510 with 120° field of view 520 monitors interactions between an active speaker 530 and a listener 540, while tracking a secondary speaker 550 outside a primary attention zone. SAA maintains awareness within a primary attention zone 560 and tracks gaze direction 570 while respecting social distance markers 580 at 1 m and 2 m radii. Active conversation links 590 are monitored to generate real-time probability matrices. All measurements are shown on a 1-meter grid reference system, optimized for the device's sensor array and audio capture capabilities within the 2-3 m optimal range.

This component determines the probability of conversation between pairs of users. A probability matrix is generated by computing pairwise conversation probabilities P{i,j} using fused multimodal features. The matrix is updated in real-time, every 100 ms, with temporal smoothing. Efficient sparse matrix operations are implemented for scalability.

Confidence scoring is performed by using Bayesian confidence estimation for each probability. Uncertainty quantification is implemented using Monte Carlo dropout. Attention focus recommendation is performed using a design rank-based system for identifying likely conversation partners. A predictive model is used for anticipating attention shifts. A reinforcement learning approach is implemented for adaptive recommendations.

Conversation dynamics are modeled by a state machine for conversation lifecycle-initiation, maintenance and dissolution. Temporal consistency checks are implemented using historical data. Group conversation is detected and tracked.

Output interfaces include an API for real-time probability matrix access, an event-driven notification system for significant changes, and visualization tools for attention patterns and conversation flows.

A probability matrix is generated by computing pairwise conversation probabilities P{i,j} using fused multimodal features, where P{i,j}. denotes the probability of conversation between participants i and j. The probability matrix is updated in real-time (every 50 ms) with temporal smoothing. Efficient sparse matrix operations are implemented for scalability.

Confidence scoring is provided by using Bayesian confidence estimation for each probability. Uncertainty quantification is implemented using Monte Carlo dropout.

Audio gain is managed using base gain levels
normal gain: 1.0 (0 dB)—base level for active conversation participants; and
reduced gain: 0.8 (−1.9 dB)—for non-primary conversation streams.

A minimum gain is set to 0.2 (−14 dB), which is a floor level for maintaining awareness. Updating is performed at a rate of 20 Hz, aligned with a system update rate.

Context-aware gain control is performed. In a dialogue mode with group discussion, balanced gains are maintained across all participants, with quick response to turn-taking, and preserving spatial cues for speaker localization. Split conversations are identified by a clear gain separation between conversation pairs. Awareness of other conversations is maintained, and transitions are gradual during group splits and merges.

For a conversation with disengagement, gain is reduced for the disengaged participant. A minimal awareness level is maintained, with quick gain recovery upon re-engagement.

Transition smoothing is implemented with temporal ramping for gain changes at 50 ms or more frequent update intervals. Hysteresis is applied to prevent rapid gain fluctuations. Artifact-free transitions are ensured between conversation states.

Output interfaces include an application programming interface (API) for real-time probability matrix access. An event-driven notification system for significant changes is implemented. Visualization tools are provided for attention patterns and conversation flows.

### Hardware Integration Architecture

The system integrates with wearable device hardware through a layered architecture that efficiently manages sensor data and processing capabilities. The hardware foundation consists of five key components: (i) depth cameras operating at high frame rates for spatial positioning and environment mapping with stereoscopic depth perception capabilities, (ii) eye tracking system with infrared illumination for precise gaze direction monitoring and sub-millimeter accuracy pupil tracking, (iii) spatial audio array with multiple microphones for directional audio capture and spatial audio processing, (iv) motion tracking system with inertial measurement capability for precise motion detection and degrees of freedom tracking, and (v) a processing unit comprising a multi-core processor with neural network acceleration capabilities and graphics processing resources.

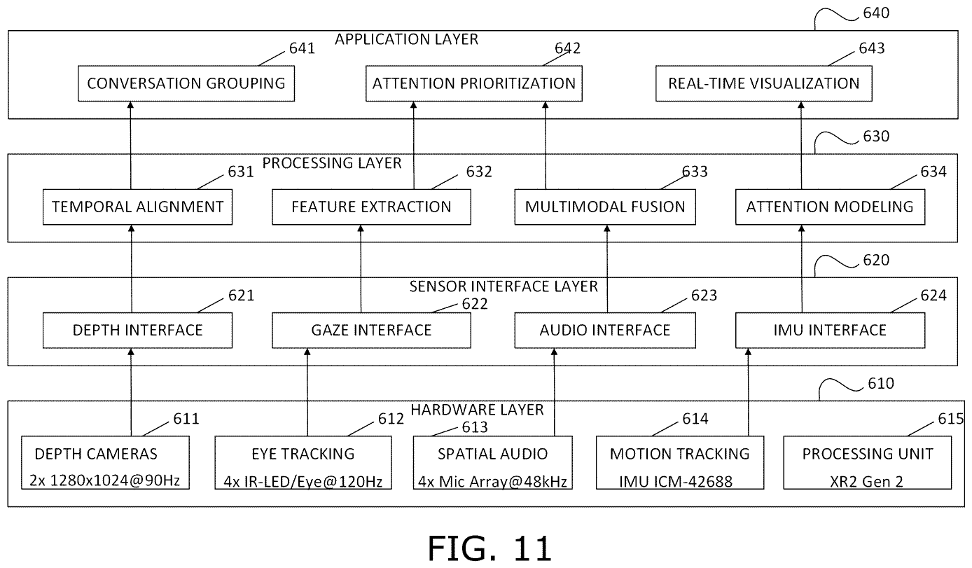

Reference is made to FIG. 11, which is a hierarchical block diagram illustrating the hardware integration architecture of the SAA system across multiple processing layers, in accordance with an embodiment of the present invention. The system includes four primary layers: (i) hardware layer 610, containing physical sensors including dual depth cameras operating at high frame rates, eye tracking system with infrared illumination, spatial audio array with multiple microphones, motion tracking system, and processing unit; (ii) sensor interface layer 620, managing raw data acquisition through dedicated interfaces for depth 621, gaze 622, audio 623, and IMU 624 data streams; (iii) processing layer 630, implementing core SAA algorithms including temporal alignment 631, feature extraction 632, multimodal fusion 633, and attention modeling 634; and (iv) application layer 640, providing user-facing functionalities including conversation grouping 641, attention prioritization 642, and real-time visualization 643. Signal flow paths, indicated by vertical arrows, show data progression from hardware sensors through interface and processing stages to final applications, maintaining parallel processing streams for each modality while enabling cross-modal integration at the processing layer.

### Interface Layer 620

Four dedicated interfaces manage raw sensor data, depth interface 621, gaze interface 622, audio interface 623 and IMU interface 624.

Depth interface 621 processes stereoscopic depth data, handles spatial mapping calculations, and provides positional tracking data.

Gaze interface 622 manages eye tracking data streams, processes pupil detection and tracking, and calculates gaze direction vectors.

Audio interface 623 handles spatial audio processing, manages microphone array data, and provides audio feature extraction.

IMU interface 624 processes motion sensor data, handles rotational updates, and integrates movement tracking.

### Processing Layer 530

Core processing consists of four primary components; temporal alignment 631, feature extraction 632, multimodal fusion 633, and attention modeling 644.

Temporal alignment 631 synchronizes multi-sensor data streams, manages varying sensor sampling rates, and ensures coherent data integration.

Feature extraction 632 processes raw sensor data, extracts relevant features for attention modeling, and prepares data for fusion processing.

Multimodal fusion 633 combines features from multiple sensors, implements cross-modal integration, and generates unified data representation.

Attention modeling 634 processes fused data for attention analysis, implements attention prediction algorithms, and generates attention state estimates.

### Application Layer 640

Three main applications utilize the processed data-conversation grouping 641, attention prioritization 642, and real-time visualization 643.

Conversation grouping 641 identifies and tracks conversation participants, manages group dynamics, and updates conversation state models.

Attention prioritization 642 determines primary attention targets, manages attention switching, and handles priority calculations.

Real-time visualization 643 provides visual feedback, renders attention state information, and updates user interface elements.

### Comprehensive Computational Resource Management

Given the constrained resources of wearable devices, the SAA model employs a comprehensive set of strategies to efficiently utilize computational and power resources, including asynchronous and parallel processing, dynamic computation scaling, hardware-specific optimizations, quantization and compression, an adaptive computation graph, and a power-aware design.

Regarding asynchronous and parallel processing, SAA employs parallel processing of different modalities-audio, visual and spatial, using both CPU and GPU. Dedicated threads are used for input preprocessing, model inference and output generation. SAA leverages task-level parallelism to maximize hardware utilization.

Regarding dynamic computation scaling, SAA employs adaptive computation based on the complexity of the current scene or conversation, dynamically adjusts the number of active neural network layers, attention heads, and feature channels, and implements early-exit mechanisms to short-circuit computation for simple inputs. SAA employs workload-aware dynamic voltage and frequency scaling (DVFS) to optimize power consumption.

Regarding hardware-specific optimizations, SAA employs GPU acceleration for computationally intensive operations, such as matrix multiplications and attention mechanisms. SAA uses digital signal processing (DSP) cores for efficient audio processing, including voice activity detection and feature extraction. SAA leverages SIMD instructions on the CPU for parallelized computations. SAA employs memory-efficient implementations, including custom memory allocators and tensor pooling.

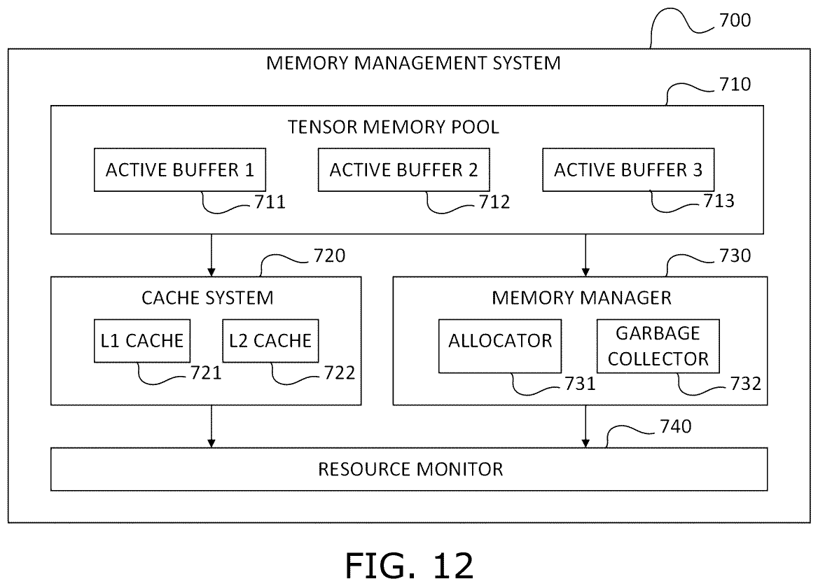

Reference is made to FIG. 12, which is a simplified diagram of a memory management system 700 with memory allocation and tensor pooling, in accordance with an embodiment of the present invention. FIG. 12 shows a tensor pool 710 with three active buffers 711, 712 and 713, a cache system 720 with local caches 721 and 722, and a memory manager 730 with an allocator 731 and a garbage collector 732, and a resource monitor 740.

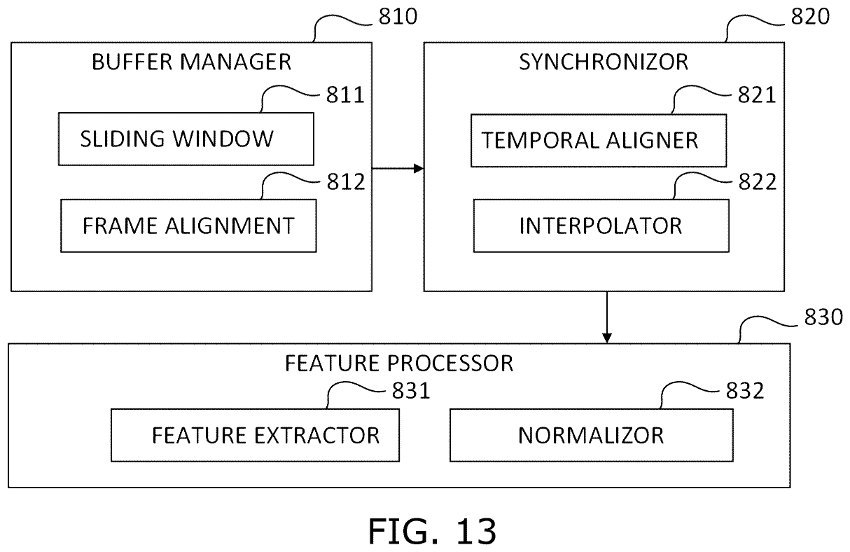

Reference is made to FIG. 13, which is a simplified diagram of buffer management for synchronization and feature processing, in accordance with an embodiment of the present invention. FIG. 13 shows buffer manager 800 having a sliding window 811 and frame alignment 812, synchronizer 820 having a temporal aligner 821 and an interpolator 822, and feature processor 830 with feature extractor 831 and normalizer 832.

Regarding quantization and compression, SAA employs quantization-aware training to prepare the model for efficient int8 inference. SAA employs post-training static and dynamic quantization techniques, and model pruning and sparsity-inducing regularization to reduce model size.

Regarding an adaptive computation graph, SAA dynamically adjusts the neural network depth and width based on input complexity. SAA employs conditional layer activation to selectively enable or disable network components, and sparse attention patterns to reduce computational load without sacrificing accuracy.

Regarding a power-aware design, SAA employs power modeling and profiling to identify energy-hungry components, power-aware scheduling and resource allocation to minimize energy consumption, and lightweight listening mode for periods of low activity to conserve power.

Efficient memory management is crucial for achieving real-time performance on resource-constrained devices. The SAA model employs a multi-level memory architecture to optimize data locality and minimize transfer overheads.

The system implements an efficient multi-level memory architecture optimized for real-time processing of multimodal data streams. The memory hierarchy includes zero-copy buffers and multi-level caching to minimize data transfer overhead and ensure efficient access patterns for different types of sensor data.

The memory manager uses the following best-fit algorithm.
1. Find the smallest free block that satisfies the allocation request;
2. If the block is larger than the request by a threshold (e.g., 128B), split the block;
3. Remove the selected block from the free list and return its address; and
4. If no suitable block is found, request more memory from the OS.

The system is optimized for modern mixed reality processors. The processing architecture contains a heterogeneous mix of high-performance and efficiency cores with different performance and power characteristics. The system carefully maps various processing tasks onto appropriate cores to maximize performance while minimizing power consumption.

The system implements efficient task distribution across available processing resources, allocating computationally intensive tasks to high-performance processing units while routing background tasks to efficiency-oriented processors. The processing architecture employs parallel execution paths for feature extraction, attention computation, and system monitoring, with dynamic load balancing based on available resources and processing requirements.

The SAA model contains several performance-critical kernels that are offloaded to the Hexagon DSP for acceleration. These include the MFCC feature extraction pipeline, Kalman filtering, and voice activity detection. The MFCC kernel implements the following operations.

### 1. Pre-Emphasis:

$$y [ n ] = x [ n ] - 0.97 \times x [ n - 1 ] \qquad ( 57 )$$

### 2. Windowing:

$$y [ n ] = x [ n ] \times ( 0.54 - 0 \text{.46} \times cos ( 2 π n / ( N - 1 ) ) ) \qquad ( 58 )$$

$$N = 400 ( 25 ms at 16 kHz ) .$$

### 3. FFT:

$$Y [ k ] = Σ x [ n ] \times exp ( - j 2 π kn / N ) , k = 0 , … , N - 1 \qquad ( 59 )$$

4. Mel filterbank:

$$M [ m ] = Σ {\vert Y [ k ] \vert}^{2} \times H\_m [ k ] , m = 0 , … , 39 \qquad ( 60 )$$

H_m[k]: triangular mel filterbank, 40 filters, 50 Hz-8 kHz range.

### 5. Log Compression:

$$M\_log [ m ] = log ( M [ m ] + 1 e - 6 ) \qquad ( 61 )$$

### 6. DCT:

$$C [ n ] = Σ cos ( π ( m + 0.5 ) n / 40 ) \times M\_log [ m ] , \qquad ( 62 )$$

$$n = 0 , … , 12.$$

The Kalman filtering kernel uses the following equations.

### Prediction Step:

State prediction:

$$x [ n \vert n - 1 ] = Fx [ n - 1 \vert n - 1 ] + Bu [ n ] \qquad ( 63 )$$

Covariance prediction:

$$P [ n \vert n - 1 ] = FP [ n - 1 \vert n - 1 ] F \hat{} T + Q \qquad ( 64 )$$

### Update Step:

Kalman gain:

$$K [ n ] = P [ n \vert n - 1 ] H \hat{} T ( HP [ n \vert n - 1 ] H \hat{} T + R ) \hat{} ( - 1 ) \qquad ( 65 )$$

State update:

$$x [ n \vert n ] = x [ n \vert n - 1 ] + K [ n ] ( z [ n ] - Hx [ n \vert n - 1 ] ) \qquad ( 66 )$$

Covariance update:

$$P [ n \vert n ] = ( I - K [ n ] H ) P [ n \vert n - 1 ] \qquad ( 67 )$$

The system implements optimized processing techniques for attention mechanisms and neural network operations, using hardware acceleration where available. The implementation fuses multiple operations to minimize memory access and maximize computational efficiency.

The system implements optimized processing techniques including mixed-precision computation, parallel reduction operations, and fused layer calculations to maximize computational efficiency while minimizing memory bandwidth requirements. These optimizations enable efficient execution of attention mechanisms and neural network operations on available processing hardware.

To fully utilize the available memory bandwidth, the SAA model employs various optimization techniques to minimize data movement and maximize locality.

The custom allocator uses the following parameters. Memory pool size: 16 MB, block sizes: 64B, 128B, 256B, 512B, 1 KB, 2 KB, 4 KB, alignment: 64B.

The data layout for feature maps uses the following format. Spatial features: [batch, height, width, channels], audio features: [batch, time, frequency, channels], gaze features: [batch, time, 2].

The software pipelining uses the following double-buffering scheme. Buffer 0: Used for current batch processing, buffer 1: used for prefetching the next batch, buffer size: 2 MB each.

To maximize the battery life, the SAA model employs various power management techniques to dynamically adjust the hardware resources based on the workload requirements.

The DVFS controller uses the following algorithm.
1. Measure the execution time of each processing stage for the current frame;
2. Calculate the average execution time over the last N frames (e.g., N=10);
3. If the average execution time exceeds the target latency:
   increase the CPU/GPU frequency by a step size (e.g., 100 MHz); and
   if the frequency is already at the maximum, skip to step 5;
4. If the average execution time is below the target latency by a margin (e.g., 20%):
   decrease the CPU/GPU frequency by a step size; and
   if the frequency is already at the minimum, skip to step 6;
5. If the frequency cannot be increased further, reduce the model complexity:
   reduce the number of attention heads by 1; and
   reduce the feature map resolution by a factor of 2;
6. If the frequency cannot be decreased further, increase the model complexity:
   increase the number of attention heads by 1; and
   increase the feature map resolution by a factor of 2; and
7. Wait for the next frame and repeat from step 1.

The system implements dynamic power management based on processing requirements and input characteristics. The system analyzes workload complexity across multiple dimensions including:

Spatial complexity: measure participant movement and positioning patterns.

Temporal complexity: track rates of change in spatial relationships.

Conversation complexity: monitor interaction patterns and turn-taking behavior.

Based on these complexity metrics, the system dynamically adjusts processing parameters and resource allocation to maintain optimal performance while managing power consumption.

The SAA model includes a comprehensive performance monitoring system that collects various metrics at runtime and provides visibility into the model's execution behavior.

The monitoring system collects the following metrics. CPU utilization: percentage of time each core is active-sampling rate=100 Hz, buffer size=1000 samples. GPU utilization: percentage of time the GPU is active-sampling rate=100 Hz, buffer size=1000 samples. Memory bandwidth: amount of data transferred per second-sampling rate=10 Hz, buffer size=100 samples. Cache hit rates: percentage of memory accesses that hit in each cache level-sampling rate=10 Hz, buffer size=100 samples. Power consumption: average power draw in Watts, sampling rate=1 Hz, buffer size=60 samples. Thermal state: average temperature in degrees Celsius-sampling rate=1 Hz, buffer size: 60 samples.

The SAA model contains an optimization feedback loop that continuously learns and adapts the model parameters based on the runtime data.

The online learning algorithms use the following parameters. Gradient descent-learning rate=0.01, momentum: 0.9, batch size: 32. Evolutionary strategies-population size=50, mutation rate: 0.1, crossover rate=0.5, selection method=tournament selection. Reinforcement learning-algorithm=proximal policy optimization (PPO), actor learning rate=0.0001, critic learning rate=0.001, discount factor=0.99, entropy coefficient=0.01.

The heuristics and rules encode the following domain knowledge. The number of attention heads should be proportional to the spatial complexity. The number of transformer layers should be proportional to the conversation complexity. The feature map resolution should be proportional to the temporal complexity. The batch size should be inversely proportional to the memory bandwidth utilization.

The feedback loop operates at the following time scales-real-time updates every 100 ms, offline processing every 10 minutes.

The system achieves real-time performance suitable for interactive applications, with end-to-end processing latency meeting requirements for natural conversation flow. The attention modeling maintains high accuracy in conversation grouping while operating within the power and thermal constraints of wearable devices.

The model's expected output is a probability matrix P{i,j} where each cell represents the likelihood that participant i is in conversation with participant j. This matrix is updated in real-time, with a refresh rate meeting or exceeding the minimum requirements for wearable devices (90 Hz or higher) to ensure smooth operation.

The optimization feedback loop, combined with the real-time adaptation system and performance monitoring, enables the SAA model to continuously improve its performance and adapt to varying conversational scenarios while operating within the resource constraints of mixed reality devices. By dynamically adjusting the model parameters and processing pipeline based on the input characteristics and hardware limitations, the SAA model can maintain a high level of accuracy and real-time responsiveness across a wide range of use cases and environmental conditions.

### Extensions

Sensor data used by SAA extends to include full body tracking via cameras and sensors. SAA implements real-time skeletal tracking using computer vision algorithms and pose tracking such as with EGOALLO. Pose estimation models are optimized for camera placement. Fusion algorithms combine head-mounted and body tracking data. Advantages of full body tracking include enhanced recognition gesture for non-verbal communication cues, more accurate user positioning and orientation in 3D space, and improved social presence in multi-user scenarios.

Sensor data used by SAA also extends to include physiological signals for user engagement assessment. SAA integrates heart rate variability (HRV) data. SAA uses electrodermal activity (EDA) sensors. Use of physiological signals results in enhanced ability to detect user engagement and stress levels.

Sensor data used by SAA also extends to include haptic feedback for enhanced user interaction. SAA uses subtle haptic patterns to indicate attention shifts, and implements directional haptic cues for spatial awareness. Use of haptic data enhances the user experience with intuitive, non-visual attention guidance.

The SAA model includes efficient algorithms for real-time full body tracking with limited computational resources. SAA ensures privacy and data security for physiological measurements. SAA balances the additional computational load of body tracking with real-time performance requirements. SAA integrates body tracking data seamlessly with existing gaze and EEG modalities.

The SAA model also includes advanced natural language processing (NLP) with liquid neural networks for conversational dynamics. SAA performs adaptive keyword and phrase detection by implementing LNN-based real-time keyword spotting system, utilizing dynamic computational units to adapt to changing conversation topics, and importance scoring mechanism for detected keywords based on conversational context.

SAA provides continuous subject matter tracking using an LNN architecture with long-term and short-term memory components. SAA implements topic continuity scoring using time-constant networks. SAA uses subject matter graphs to visualize topic evolution in real-time.

SAA uses predictive language modeling for latency reduction, utilizing a LNN-based next-word prediction model and structured operators for efficient processing of word sequences. SAA implements adaptive beam search for real-time hypothesis generation.

SAA uses conversational rhythmicity analysis utilizing a LNN model to detect and analyze speech rhythm patterns. SAA implements time-varying attention mechanisms to focus on rhythmic features. SAA generates speaker-specific rhythm profiles for improved conversation grouping.

SAA performs multi-speaker conversation prediction using a LNN architecture for real-time speaker turn prediction, dynamic time-constant networks to adapt to varying conversation speeds, and confidence scoring for predicted speaker transitions.

SAA also performs contextual relevance modulation using a LNN-based attention modulation system, and a dynamic relevance scoring mechanism for incoming speech segments. SAA implements adaptive thresholding for relevance based on the user's current focus.

SAA also performs cross-statement semantic linking using a LNN model for real-time semantic similarity computation. SAA utilizes a dynamic knowledge graph construction using structured operators, and an adaptive linking threshold based on conversation coherence.

SAA also performs prosodic feature integration using LNN modules for real-time prosody analysis-pitch, intonation, stress, and a fusion mechanism to integrate prosodic features with lexical content. SAA implements prosody-based emphasis detection for keyword reinforcement.

SAA also performs conversation flow prediction using a LNN-based conversation trajectory modeling and multi-scale time constant networks for short and long-term predictions. SAA includes visualization tools for predicted conversation paths.

SAA also performs adaptive noise and interruption handling using a LNN architecture for real-time speech denoising and dereverberation, with interruption detection and handling using dynamic computational units and continuity preservation mechanisms for interrupted speech.

SAA includes a unified LNN framework that integrates all conversational dynamics components, and implements efficient on-device training for continuous adaptation to user's conversational patterns. SAA is optimized for low-power operation using LNN's efficient inference capabilities. SAA provides adaptive computation graphs for dynamic resource allocation based on conversation complexity.

SAA employs user-specific attention models on-device fine-tuning of attention parameters and continuous learning from user interactions.

SAA employs adaptive thresholds for attention-switching, using algorithms to dynamically adjust attention sensitivity, and incorporating user feedback and historical data for threshold optimization. Use of adaptive thresholds results in more natural and personalized attention transitions.

SAA also employs customizable prioritization schemes, with a user interface for defining custom attention rules, and a flexible attention policy framework. An exemplary use case is allowing different modes for professional vs. social settings.

SAA incorporates privacy-preserving personalization techniques. SAA also incorporates methods for efficient transfer learning on edge devices, and reinforcement learning approaches for adaptive attention policies.

SAA uses techniques for managing multiple simultaneous conversation clusters, algorithms for dynamic conversation cluster detection, and multi-focus attention mechanisms.

SAA uses efficient algorithms for dynamic speaker entry and exit, using adaptive embedding techniques for new speakers, and fast speaker diarization for changing group compositions. SAA has a latency of <500 ms to adapt to new speakers.

SAA manages increased computational complexity with more participants, using efficient attention mechanisms that scale sub-linearly, and balancing model complexity with real-time performance constraints.

SAA has on-device processing techniques that are secure and private. SAA implements fully on-device inference to minimize data transmission, and uses privacy-preserving feature extraction methods. SAA ensures that no raw audio or video data leave the device.

SAA implements user consent and data control mechanisms: SAA has granular privacy settings for different data types, dynamic consent management for varying contexts, and user-friendly interfaces for data access and deletion.

SAA employs federated learning approaches, using federated averaging techniques for model updates, and secure aggregation protocols for privacy-preserving learning. SAA balances model improvement with user privacy.

SAA has adversarial robustness, using methods to detect and mitigate adversarial attacks, and differential privacy techniques in model training. SAA maintains performance under potential adversarial inputs.

SAA uses homomorphic encryption for secure multiparty computation. SAA uses privacy-preserving attention mechanisms. SAA uses trusted execution environments (TEEs) for sensitive computations.

SAA provides APIs for seamless integration with other attention-related applications. Specifically, SAA provides a flexible API for attention data access, and SAA implements real-time hooks for external applications. SAA enables third-party developers to leverage SAA capabilities.

SAA provides a unified framework for auditory attention management in multi-device environments, using multimodal sensor inputs to create a common representation for spatial audio processing, priority management across physical and virtual spaces, and consistent user experience across diverse interaction scenarios. The framework processes inputs from various devices including wearables, headsets, and computing devices to enhance auditory attention control in environments where physical and virtual participants engage in conversation. The system enables seamless audio management across mixed reality, virtual reality, and augmented reality scenarios, while supporting integration with various applications and devices in shared physical spaces.

SAA processes multi-user collaborative scenarios, using protocols for shared attention spaces and methods for privacy-aware attention sharing across physical and virtual environments. An exemplary use case is enabling shared focus in distributed team meetings.

SAA implements cross-modal learning and augmentation, using methods for audio-driven attention modeling and techniques for visually-guided audio enhancement. SAA provides immersive and intuitive experiences in mixed reality environments.

SAA implements a microservices architecture for modular integration, uses standardized data formats for attention-related information, and supports cross-platform integration for mixed reality applications.

These capabilities expand the SAA model, addressing the challenges of attention modeling in multi-device environments. The system balances practical improvements with innovative approaches for auditory attention modeling across physical and virtual spaces.

SAA integrates various sensory modalities, including full body-tracking and physiological data for enhanced attention modeling, and haptic feedback for intuitive user interactions.

SAA uses advanced natural language processing, using real-time speech recognition and sentiment analysis, and multilingual support for global applications.

SAA supports personalization and adaptive learning, using user-specific attention models that learn from individual behaviors, and privacy-preserving personalization techniques.

SAA scales to larger and more dynamic group conversations. The SAA model extends to handle 10-15 participants efficiently, using techniques for managing multiple simultaneous conversation clusters.

SAA supports privacy and security, using on-device processing and federated learning approaches, and robust user consent and data control mechanisms.

SAA seamlessly integrates with diverse applications using standardized APIs for attention-aware experiences and cross-modal learning and augmentation techniques.

### System Features and Advantages

The system implements several privacy-preserving features, including user data controls, secure attention data processing, and configurable privacy settings. The system provides granular control over personal data and attention information through dedicated privacy management modules.

The system incorporates accessibility features to support diverse user requirements. These features include configurable audio enhancement parameters, customizable attention tracking thresholds, and adaptive interface options to accommodate different user needs and preferences.

The system provides transparency in attention modeling through explainable decision outputs and validation mechanisms. The attention modeling component generates interpretable attention states and provides validation metrics for system decisions.

The system enables customization for different usage environments through configurable parameters and operational modes. These modes include settings optimized for educational environments, professional settings, and social scenarios.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

1-11. (canceled)

12. A method for distributed attention processing, comprising:
receiving sensor data streams from multiple participant devices to a local processing server;
performing attention modeling computations on the server; and
streaming attention-based audio adjustment parameters back to the devices.

13. The method of claim 12 further comprising applying sliding window processing for real-time sensor data integration.

14. The method of claim 12 further comprising managing multiple concurrent data streams from participant devices.

15. The method of claim 12 further comprising synchronizing data processing across server and device components.

16. The method of claim 12 further comprising prioritizing processing based on conversation dynamics.

17. The method of claim 12 further comprising implementing efficient data streaming between server and devices.

18. The method of claim 12 further comprising maintaining temporal alignment between server processing and device outputs.

19. The method of claim 12 further comprising providing failover handling for connection interruptions.
